(19) United States
(12) Patent Application Publication
(10) Pub. No.: US 2002/0111907 A1
(43) Pub. Date: Aug. 15, 2002

(54) Systems and methods for conducting electronic commerce transactions requiring micropayment

(76) Inventor: Marvin T. Ling, Scottsdale, AZ (US)

Correspondence Address: FISH & NEAVE, 1251 AVENUE OF THE AMERICAS, 50TH FLOOR, NEW YORK, NY, 10020-1105, US

(21) Appl. No.: 10/057,420

(22) Filed: Jan. 25, 2002

Related U.S. Application Data
(63) Continuation-in-part of application No. 09/753,784, filed on Jan. 2, 2001.
Application No. 09/753,784 is a continuation-in-part of application No. 09/665,237, filed on Sep. 18, 2000.
Application No. 09/665,237 is a continuation-in-part of application No. 09/553,695, filed on Apr. 21, 2000.
(60) Provisional application No. 60/178,239, filed on Jan. 26, 2000.
(60) Provisional application No. 60/311,446, filed on Aug. 9, 2001.

(51) Int. Cl. G06F 17/60

(52) U.S. Cl. 705/41

(57) ABSTRACT

Systems and methods for conducting electronic commerce using electronic tokens are described. The electronic tokens are issued and maintained by a micropayment service provider. Tangible goods, content or services offered by member vendors can be purchased or rented using the electronic tokens. A vendor and a user security means is provided to prevent unauthorized use of the user's account to purchase content, to prevent unauthorized downloading of content from a vendor web site and to prevent unauthorized change of transaction data. Settlement of payments between the micropayment service provider and the vendor is aggregated and may be performed upon reaching pre-determined amount or time thresholds, thus reducing transaction costs.

### REFERENCE TO RELATED APPLICATIONS

This application is a continuation-in-part of U.S. patent application Ser. No. 09/753,784 filed Jan. 2, 2001, which is a continuation-in-part of Ser. No. 09/665,237, filed Sep. 18, 2000, which is a continuation-in-part of U.S. patent application Ser. No. 09/553,695, filed Apr. 21, 2000. This application also claims priority from U.S. provisional application Ser. No. 60/178,239, filed Jan. 26, 2000, and U.S. provisional application Ser. No. 60/311,446, filed Aug. 09, 2001.

### FIELD OF THE INVENTION

This invention relates generally to systems and methods for conducting electronic commerce transactions requiring micropayments to purchase content, goods, or services. More specifically, the present invention provides systems and methods for purchasing digital content with ease and in a safe and private manner without incurring high transaction costs.

### BACKGROUND OF THE INVENTION

The Internet and the World Wide Web (hereinafter “the web”) have revolutionized the ways in which information is disseminated and shared. At any given time, the Internet enables millions of users worldwide to simultaneously access a wide variety of information and engage in activities as diverse as shopping, playing games, and financial trading, among others.

Users can access Internet information through various “Internet appliances”, which are electronic devices configured with an Internet access system. Internet appliances include, but are not limited to, microprocessor based devices such as personal and portable computers, and handheld appliances such as personal digital assistants and electronic organizers.

Typically, the information is accessed through a connection to a “web page,” a multimedia composition that is displayed to the user on a “web browser window” by “web browser software.” Under the control of a user, the web browser software establishes a connection over the Internet between the user's Internet appliance, and a “web server.” This connection is used to download data representing a web page from the web server to the user's Internet appliance. Web pages may contain text, audio, graphics, imagery, and video, as well as nearly any other type of content representation that may be experienced through use of a computer or other electronic device. Additionally, web pages may be interactive, and may contain user selectable links that cause other web pages to be displayed, forms that may be used to send information from the user to the web server, interactive executable code, or other elements through which the user may interact with web pages. A group of one or more interconnected and closely related web pages, such as all the web pages containing information about a single company, located on one or more web servers, is referred to as a “web site.”

At present, many of the fastest growing web sites in terms of users are electronic commerce (“e-commerce”) web sites that offer a variety of content, services, and tangible goods for sale. Such content includes, but is not limited to, newspaper articles, music, movies, games, video, and software, or other non-tangible goods that may be purchased and distributed in electronic form. Examples of services offered for sale in e-commerce web sites include online technical support, medical and legal advice, and personal fitness training, among others. Tangible goods offered online range from books, clothing, food, and toys, to more expensive items such as art pieces, automobiles, homes, and furniture, or other goods that may be shipped directly to consumers.

Electronic commerce transactions involving tangible goods usually start with the user visiting an e-commerce web site directly or visiting an “e-commerce aggregator” web site that displays a list of e-commerce web sites for various categories of products. For example, users may go to the Amazon.com web site to purchase books directly from Amazon.com, Inc., of Seattle, Wash., or users may go to the Yahoo! shopping e-commerce aggregator web site maintained by Yahoo!, Inc., of Sunnyvale, Calif., to search for books on a number of online bookstores, including Amazon.com and Barnesandnoble.com, among others.

To complete an e-commerce transaction culminating in the purchase of one or more tangible goods, users typically follow two steps. The first step involves spending some time browsing the e-commerce web site searching for the desired tangible goods, which may take anywhere from a few seconds to a couple of hours, depending on the Internet traffic conditions at the time and on the design and user-friendliness of the web site. The tangible goods selected by the user are collected in an electronic “shopping cart”, which allows the user to update a list of the tangible goods selected while browsing to include only those desired for purchase, similar to a grocery store shopping cart. In the second step, after having updated the shopping cart, users go through a “check-out” process in which all pertinent information required to complete the transaction is entered by the user on a number of forms provided in the e-commerce web site. The information required during the check-out process may include personal information such as the user's name, address, and e-mail, payment information, and shipping information. Most e-commerce web sites also ask users whether they want this information to be saved for future web site visits in order to speed up the check-out process. Users may then select a “log-in” user ID and password to be used for later purchases.

Currently, there are a variety of payment methods that may be chosen by users to purchase tangible goods on e-commerce sites. The most prevalent and sometimes the only payment method available consists of credit card payments, in which the user simply provides a credit card number to the e-commerce web site. The e-commerce web site then validates the credit card number through secure communications to the appropriate financial authorities prior to completing the transaction. Other payment methods available to users include the use of individual accounts established with vendors, gift certificates or electronic coupons, electronic checks proposed by the NetCheque system developed at the Information Sciences Institute at the University of Southern California, of Los Angeles, Calif., several electronic currencies, and the use of electronic payment services provided by various Internet payment service providers.

The simplest of these payment methods is for users to establish individual accounts with each e-commerce vendor. The user has separate accounts for each vendor, and the vendor maintains accounts for every customer. When a user wants to purchase an item at a vendor's web site, the user opens an account and the vendor adds the cost of the item to the user's account. The vendor maintains the account information and bills the user periodically.

Another payment method that is simple for users to use includes electronic currencies such as “Digicash”, proposed by eCash Technologies, Inc., of Bothell, Wash., “InternetCash”, proposed by InternetCash Corp., of New York, N.Y., and “Beenz”, proposed by Beenz.com, Inc., of New York, N.Y. The Digicash and InternetCash currencies are issued to users by selected banks and may be spent on selected e-commerce web sites to purchase tangible goods without requiring a credit card. The Digicash currency system relies on encryption and signature technology to authenticate the user and guarantee the security of payments made with Digicash. While users may exchange any amount of real currency for Digicash, InternetCash may be purchased only at pre-determined denominations by means of a pre-paid card. Both Digicash and InternetCash currencies require users and e-commerce web sites to make arrangements with authorized banks to convert between the electronic currencies and real currencies.

Unlike Digicash and InternetCash, the Beenz currency may not be purchased by users, but rather, it can only be earned by users as an incentive for visiting particular web sites, shopping online at selected sites, and other types of online activities. Users may then purchase goods at selected web sites with the earned Beenz currency, which can only be converted to real currencies by the e-commerce vendors through an authorized bank.

In addition, numerous patents on electronic currency have also been issued. Among these are U.S. Pat. No. 5,983,207, issued to Turk et al., and U.S. Pat. No. 5,671,364 issued to Turk, which discuss electronic currency systems based on gold or some other commodity held at a central location. U.S. Pat. No. 4,977,595, issued to Ohta et al., describes cryptographic techniques that may be used by a bank to issue electronic cash. Like the other electronic currency systems described hereinabove, the methods described in these patents use central organizations, such as banks, to manage user accounts and to handle transactions. Such electronic currency systems necessarily impose overhead, in that both the vendors who accept these various forms of electronic currency and the users who buy items in exchange for electronic currency must deal with a central organization, such as a bank. Further, such systems are not as easy for users to use for purchasing online content by simply clicking on a content URL. These systems require users to go through too many processes for a simple content purchase that may only cost a few cents.

Another approach that may be used to make electronic payments online for the purchase of tangible goods is provided by various systems developed by Internet payment service providers. One such system is provided by RocketCash Corporation, of Mountain View, Calif. The RocketCash system enables users to set up accounts at a web site and add money to the account using checks, money orders, or credit cards. Users may then purchase tangible goods at one of the e-commerce web sites listed in the RocketCash web site that accepts payments through RocketCash accounts. The e-commerce web sites that accept RocketCash accounts are controlled by the RocketCash web site so that users must first go through the RocketCash web site in order to connect to the e-commerce web sites listed on the RocketCash web site. Users are also awarded redeemable points called “RocketFuel” as incentives for using their RocketCash accounts, similar to being awarded frequent flier miles on airlines. Additionally, RocketCash may provide discounts to users at selected e-commerce web sites.

Another payment method that is simple for users to use includes electronic person-to-person (“P2P”) systems such as “c2it”, developed by Citibank of Citigroup, Inc., of New York, N.Y., and “PayPal”, developed by PayPal, Inc., of Palo Alto, Calif. The “c2it” and “PayPal” P2P systems are used to transmit funds online from one person to another via e-mail. Users can send funds to another user who has set up an account, similar to a Western Union electronic transmittal of funds. The user deposits the funds into his/her bank account and/or credit card and then transmits the funds via their e-mail address. The transmittal of funds is still dependent on a third-party bank to facilitate the funds transfer. In the case of purchasing tangible goods such as from auction sites, such P2P systems are used to transmit funds from the buyer to the seller. These systems are not suitable for readily purchasing online content.

Although there are variety of payment methods available for the purchase of tangible goods on e-commerce web sites as described hereinabove, these payment methods are not suitable for the online purchase of content. Unlike most tangible goods offered for sale online, content is usually offered free of charge, bundled with other content in subscription-based models, or priced on a permanent use, rental use, per-use or per-view basis. In addition to content, services such as online technical support may also be offered on a pay-per-use basis.

The price for each content item may sometimes amount to a few cents to a few dollars or even the equivalent of a fraction of a cent. These prices for content are much smaller than the typical fee associated with processing credit card transactions or with subscription based models. Hence these payments are referred to as “micropayments.”

For e-commerce transactions requiring micropayments, it is necessary to provide payment methods that do not incur the overhead of processing fees and charges that are common to individual accounts at vendors'web sites, credit card payments, electronic currencies, and the various systems provided by Internet payment service providers described hereinabove.

The purchasing of content, tangible goods, or services requiring a micropayment using a credit card is not feasible because the credit card company settles the payment immediately at the time of the business transaction regardless of the amount of purchase, thereby making the cost of settling payments and the overhead for the credit card company to manage millions of these micropayments and their credit card fees uneconomical. In addition, credit card companies may offer various features such as individual item accounting, insurance, and fraud protection that add to the overhead costs and are not necessary for micropayment transactions. Another problem with the use of credit cards to make micropayments is that users may be unwilling to provide a credit card number to a vendor they do not know or trust. Even though the credit card may insure the user against any loss, the user still has to go through the inconvenience of handling the credit card dispute.

Using electronic currencies to pay for micropayment transactions is also not economically feasible since it requires that users and content providers rely on a central bank authority to exchange the electronic currency for real currency and vice-versa, and the transaction costs involved in the currency exchange and other fees charged by the central bank authority may be higher than the micropayments themselves. Additionally, since the central bank authority controls the issuance of the electronic currency, the e-commerce vendors who accept the electronic currency have no control over the value of the electronic currency, its sale price, and the terms on which it may be bought, or to whom the electronic currency is sold. For example, it is not possible for an e-commerce vendor of tangible goods, content, or services, to agree with its users on payment terms for electronic currencies, since the user must pay a bank or other third-party organization for the electronic currency, making both the e-commerce vendor and the user dependent and subject to the policies of the bank or of the third-party financial organization.

The payment alternative provided by the RocketCash system is also cumbersome to users due to their need to go through the RocketCash web site and to fund a RocketCash account prior to purchasing any items at authorized e-commerce web sites. If users desire to make a single micropayment costing a few cents, they would still be required to fund the RocketCash account with money deducted from a credit card, check, or money order prior to making the micropayment. Since the payment is settled immediately, users incur all the overhead and transaction cost problems associated to credit card, check, and money order payments.

Another problem with using the RocketCash system to handle micropayments is that the e-commerce web sites that accept RocketCash accounts as payment require a shopping cart and a check-out process to complete the transaction. When browsing through various e-commerce web sites that offer articles in news archives for sale, for example, it is generally not practical for a user to purchase an article or groups of articles from one or more e-commerce web sites using a shopping cart and conducting a check-out process at each and every site. And, browsing and surfing from one web site to another web site, then back to the first web site to purchase articles as one is browsing or doing research, makes purchasing for such articles using a shopping cart tedious and time-consuming. If a news article were priced at say only five cents, a user would like to click onto the title of the article, pay for it, then immediately be able to read and/or print it, all within just a few clicks. The user would then move on to search or browse for other articles offered at the same or different web sites.

In the case of music, for example, the user may also want to download one or several songs while surfing different content providers' web sites and may not necessarily want to commit to a subscription or to purchase an entire CD using the shopping cart. If a user needs to go through a check-out process, irrespective of using a shopping cart or not, such a process makes the purchase of content so inconvenient, tedious and time-consuming so as to immediately discourage the user from continuing to purchase content.

Due to the difficulties in handling micropayments for the purchase of content using credit cards, electronic currencies, or Internet payment service providers' systems such as the one proposed by RocketCash, most content providers that offer content for sale have adopted a subscription-based pricing model. The subscription model typically charges each user a monthly, quarterly, or annual fixed fee, which is large enough to justify using a credit card for payment. Examples of content providers that offer content to users based on subscriptions include The Wall Street Journal, of New York, N.Y., and EDGAR Online, Inc., of New York, N.Y. In addition to a subscription fee, The Wall Street Journal also requires users to pay an extra fee for articles in the Journal archives.

Such subscription-based models, however, are also not suitable to deal with micropayment transactions. First, subscription-based models are extremely uneconomical and cost-prohibitive because each user may download an unlimited number of content items without being concerned about the cost of any given item since the subscription method does not restrict each user as to how much content they can download during the period of the subscription. Second, subscription-based models do not provide users the flexibility of purchasing content every now and then or from various content providers without having to subscribe to each and every content provider's web site. Users may not know in advance that they will use a given content provider's web site frequently enough to justify a large subscription fee and the time to register the subscription at the site.

And lastly, when downloading an unlimited amount of content based on the payment of a subscription fee, it is much harder to compensate intellectual property owners such as authors, publishers, and musicians because royalties cannot be readily apportioned to them based on one fixed fee. Even if the content provider desires to pay a royalty associated with each downloaded content, the content provider has limited means to readily identify the content and compute the associated royalty for payment to the intellectual property owner of the content.

To address the need for payment methods that can handle micropayment transactions efficiently, a number of systems focused on micropayment transactions have been developed. Such systems include the systems provided by various micropayment service providers such as Magex Limited, of London, England, Compaq Computer Corporation, of Houston, Tex., Clickshare Service Corporation, of Williamstown, Mass. and QPass, Inc., of Seattle, Wash. Although all of these systems enable users and e-commerce vendors to make micropayment transactions online, they suffer from several drawbacks that so far have prevented micropayment transactions from becoming more prevalent on the web.

The system developed by Magex enables network operators to sell products, content, and services such as games, pay per view films and information services by providing a financial clearing service that supports micropayment transactions, advanced multi-currency capabilities, multiple account funding options, and flexible vendor settlement and clearing for both digital (e.g., gaming, gambling) and physical goods purchased. While browsing a web site, a user may download a music track, video game, or novel. A Magex logo on the vendor web site informs the user whether the content is protected within a Digibox® container—a secure container to protect the file from piracy. To open the file, the user needs to create a “Magex wallet” and download the software developed by Magex to create their own user ID and password. The user can add funds to their wallet and use the funds in the wallet to pay for the music they have downloaded.

The Magex wallet also offers a range of payment options, allowing the user to choose to pay-per-play, rent content for a set time, or make an outright purchase. However, the Magex system can only be used to purchase music and is limited to its proprietary MP3 encoding system for the user's computer. Users cannot listen to the music on any other MP3 platform such as an MP3 player. Users cannot purchase any other content in an open system format. Further, the purchase method relies on a shopping cart and a check-out process, which are not convenient for micropayment transactions online.

Another system that permits micropayment transactions online is the MilliCent system developed by Compaq Computer Corporation. The MilliCent system is based on the MilliCent secure protocol for e-commerce over the Internet. The protocol is designed to support purchases costing less than a cent and it can be used by e-commerce web sites to charge for tangible goods, content, or services, through the simultaneous use of pay-per-click purchases, subscriptions, and advertising. The protocol also can be used to make direct monetary payments to users.

The MilliCent protocol enables users to purchase items at e-commerce web sites though a broker that serves as an accounting intermediary. Brokers may be financial institutions that have a presence online such as banks and credit card companies, Internet service providers, or single broker entities created specifically for mediating online financial transactions between users and e-commerce vendors. Both users and vendors open accounts with the broker and use the accounts opened with the broker as a payment mechanism. Such accounts are called “scrips”, and consist of signed messages attesting that the scrip has a particular value.

Unlike typical cash, the scrip contains an expiration date and other parameters such as an ID for the vendor with whom the scrip can be redeemed, that is, a scrip has value only when spent with a specified vendor. A user may purchase scrips having a given value from the vendor by first purchasing a scrip with the broker and then using the broker scrip at the vendor's web site to purchase a vendor scrip that may be used to purchase items on the vendor's site. Since the vendor scrip has a pre-specified value, users receive “change scrips” whenever they purchase items that are valued less than the scrip. When the user has completed a series of transactions, the user may “cash in” the remaining value of the scrip, i.e., close the account with the vendor. Brokers make a profit by buying vendor scrips in bulk and at a discount, and selling the vendor scrips to the users at a higher price.

Although the MilliCent protocol is secure and designed to prevent fraud of vendors, users, and brokers, it does not have the flexibility to let users go to vendor web sites directly to purchase items. The overhead imposed on users to have multiple vendor accounts may discourage users from making impromptu micropayment purchases with multiple vendors. Furthermore, since vendor scrips are only sold at pre-determined values, users may not be willing to establish relationships with vendors to purchase a single or few items of interest to the user that cost less than the value of the scrip. In addition, the MilliCent system assigns too much control to the brokers, imposing an extra layer of costs and overhead to users, who must first purchase broker scrips before they can purchase vendor scrips. Lastly, since users must first purchase the broker scrip with a credit card, check, or money order before they can make a single micropayment transaction costing a few cents, they still incur all the overhead transaction cost problems associated to credit card, check, and money order payments.

The micropayment system provided by Clickshare eliminates this problem by letting users make micropayments online for the purchase of content at participating web sites listed on a web site maintained by Clickshare without having to first add funds to an account. Users must first register with a “most-trusted” participating vendor to open a Clickshare account having a user name and a password. Users specify a credit card number to be charged by Clickshare only after the users have made enough transactions totaling a high enough value. The Clickshare account opened at the most-trusted web site may be used at all the other participating vendors by entering the user's name and password only once at each vendor's web site prior to purchasing a content item. The user can then subsequently purchase content items from the same web site without having to re-enter the user's name and password for every content item purchased. The most-trusted web site may be a newspaper, Internet or wireless service provider, bank, association, retailer, portal, or specialty publisher selling or reselling text, music, video, multimedia, software, or services.

The main advantage of the Clickshare system is that it allows users to make purchases online without having to disclose their personal information to vendors. This enables users to purchase a variety of content anonymously, without having to worry that their personal information will be used by the vendors for marketing or other purposes. Another advantage is that Clickshare aggregates all the content purchases made by the user with their Clickshare account so that the purchases are debited from the user's credit card only once per month. However, if the user makes a single purchase in a given month for only fractions of a cent, the transaction costs and processing fees of debiting the purchase in the user's credit card may be higher than the purchase amount. This may impose an unnecessary minimum threshold for the price of content charged by vendors.

In addition, Clickshare allows vendors to provide content volume discounts to users so that users may purchase a number of content items over a specified time period for a discounted price. For example, users may purchase “60 articles over the next 12 months for $9.95 . . . less than 17 cents each” at the Dallas News web site. Such a volume discount is similar to a subscription, and has the same drawbacks associated with using subscription-based models for micropayment transactions.

A further drawback of the Clickshare system is that once the user selects a content item for purchase, such as a newspaper article that can be viewed online, the Clickshare system records the transaction but does not signal the user that the content item has already been purchased if the user desires to view the same content item at a later time. As a result, users may incur numerous duplicate charges at their Clickshare account. Even though users can dispute the duplicate charges at a later date by checking their account transactions on the Clickshare web site, they have no way of preventing Clickshare from making the duplicate charges prior to purchasing multiple copies of the content items.

Additionally, the content items that are purchased are controlled by Clickshare rather than the content providers. Once their content items are purchased with a Clickshare account, content providers lose control of the content and have no way of knowing whether the content item has been tampered with before being viewed by the user at Clickshare's web site. Clickshare's web site also does not provide any security mechanisms to lock the purchased content to prevent users from freely distributing the purchased content items to other users. If the URL corresponding to the content item is distributed to others, the user has no way of knowing whether someone else will view the article for free or purchase the article with the user's account.

The system provided by Qpass eliminates the security problems of the Clickshare system by locking the content purchased to the user's Qpass account that may be opened by registering at a vendor's site. That is, once a user purchases a given content item, the URL corresponding to the content item may not be distributed to others without the user's account login information. Users are required to provide their account login information every time prior to viewing a content item they had previously purchased. Other features of the Qpass system that provide advantages over the Clickshare system include its ability to offer users multiple languages and multiple currencies to choose from, with each user selecting a single language and currency to apply to Qpass purchases online, as well as its ability to prevent multiple charges on a content item that has already been purchased by the user.

The Qpass system is similar to the system provided by Clickshare in that it allows users to purchase items from e-commerce vendors' web sites directly by login in to their Qpass accounts without having to visit the Qpass web site first. The Qpass system also aggregates the micropayment purchases made by users so that users are only billed for their purchases on a monthly basis. Users may also view their current account activity online on a web site maintained by Qpass that also contains links to the content items purchased. Additionally, Qpass also offers volume discounts to users so that users may purchase a number of content items over a specified time period for a discounted price, such as articles offered at the archives of The New York Times, of New York, N.Y. Such volume discounts have the same drawbacks associated with using subscription-based models for micropayment transactions.

The Qpass system also suffers from the same drawback of the Clickshare system in that the content items purchased by users using their Qpass accounts are controlled by Qpass rather than the content providers. That is, once their content items are purchased with a Qpass account, content providers lose control of the content and have no way of knowing whether the content item has been tampered with before being viewed by the user. Further, the Qpass system also debits users' purchases once per month in their credit card so that if a user makes a single purchase in a given month for only fractions of a cent, the transaction costs and processing fees of debiting the purchase with the user's credit card may be higher than the purchase amount. This may impose an unnecessary minimum threshold for the price of content charged by vendors.

In addition, the Qpass system requires vendors to install a client on their web sites in order to offer the Qpass micropayment service to their users, which may take a considerable amount of time and effort on the part of the vendors to properly configure the Qpass client on their web sites. The Qpass system also has the drawback of having users disclose their personal information to the vendor web sites. This prevents users from making micropayment purchases online anonymously, which is a feature often requested by users who do not trust their personal information to multiple vendors.

To this date, there are no micropayment systems that offer users total privacy and security when making micropayment transactions at multiple e-commerce vendors web sites. Current micropayment systems also do not allow users to use multiple currencies and multiple languages when making micropayment transactions on web sites around the world. In addition, the micropayment systems discussed hereinabove often require the vendors to install a micropayment client on their web sites, which may require the vendors to invest significant implementation time and effort to configure the micropayment system properly. The micropayment systems described hereinabove also gain control of the content items that are offered by the vendors once the items are purchased by the users. There are also no micropayment systems that aggregate user's purchases and charge the user's credit card only after a minimum threshold has been reached rather than once a month. Additionally, there are currently no content providers who allow users to purchase one or more content items seamlessly from different vendors without requiring users to login and perform a check-out process at each and every vendor site. In short, it can be inordinately difficult and time consuming for users to make micropayment transactions online with the micropayment systems that are presently available.

In view of the foregoing drawbacks, it would be desirable to provide systems and methods for conducting micropayment transactions easily and seamlessly at multiple electronic commerce web sites to purchase tangible goods, content, or services.

It also would be desirable to provide systems and methods to enable users to make micropayment transactions at multiple electronic commerce web sites without having to disclose personal information to the web sites.

It also would be desirable to provide systems and methods for making micropayment transactions securely by preventing unauthorized use of a user's client computer to purchase content on a content provider's web site and unauthorized viewing, altering, or downloading of content from the content provider's web site.

It also would be desirable to provide systems and methods that enable electronic commerce vendors to price Internet content for pennies, a few dollars, or even the equivalent of fractions of a penny, allowing such vendors the flexibility to offer users the ability to purchase one article, publication, song, video game, movie, etc., without requiring users to pay a subscription fee to access content.

It also would be desirable to provide systems and methods that enable a user to purchase content that is priced at pennies, a few dollars, or even fractions of a penny without having to transmit credit or banking information for each and every purchase.

It also would be desirable to provide systems and methods to enable a user to easily register with a micropayment service provider, open a micropayment account with the micropayment service provider, add funds to the account using a variety of payment methods, and use the funds in the account to make micropayment transactions on multiple electronic commerce web sites using multiple currencies and multiple languages, without requiring online communication with a bank or other financial organization to complete the micropayment transaction.

It also would be desirable to provide systems and methods to enable a content provider to accept micropayments from a user's micropayment account without having to grant control of the content to the micropayment service provider or to install a micropayment service provider client on the content provider's web site.

It also would be desirable to provide systems and methods to enable users to manage their micropayment accounts by viewing an instant summary of their accounts, adding funds to their accounts, disputing micropayment transactions recorded in their accounts and receiving refunds for any transactions that were incorrectly charged, and specifying spending limits on their account per transaction, day, week, or month, for micropayment transactions made with their accounts.

It further would be desirable to provide systems and methods that permit a user the convenience to purchase content from different content providers without requiring the user to login or perform a check-out process at each and every content provider web site.

It further would be desirable to provide systems and methods that permit a user to easily access content that the user has already purchased, using an account summary, located at the web page of the micropayment service provider web site, without requiring the user to revisit the content provider's web page for that purchased content.

It further would be desirable to provide systems and methods that enable micropayment service providers to aggregate electronic commerce transactions in a user's micropayment account for payment settlement with vendors using thresholds, either by amount or by time, in order to minimize the cost of each and every electronic commerce transaction.

It further still would be desirable to provide systems and methods that enable each content provider to compensate intellectual property owners such as authors, publishers, and artists their respective royalty for each and every content item that is sold on that content provider's web site.

### SUMMARY OF THE INVENTION

In view of the foregoing, it is an object of the present invention to provide systems and methods for conducting micropayment transactions easily and seamlessly at multiple electronic commerce web sites to purchase tangible goods, content, or services.

It is also an object of the present invention to provide systems and methods to enable users to make micropayment transactions at multiple electronic commerce web sites without having to disclose personal information to the web sites.

It is also an object of the present invention to provide systems and methods for making micropayment transactions securely by preventing unauthorized use of a user's client computer to purchase content on a content provider's web site and unauthorized viewing, altering, or downloading of content from the content provider's web site.

It is also an object of the present invention to provide systems and methods that enable electronic commerce vendors to price Internet content for pennies, a few dollars, or even the equivalent of fractions of a penny, allowing such vendors the flexibility to offer users the ability to purchase one article, publication, song, video game, movie, etc., without requiring users to pay a subscription fee to access content.

It is also an object of the present invention to provide systems and methods that enable a user to purchase content that is priced at pennies, a few dollars, or even fractions of a penny without having to transmit credit or banking information for each and every purchase.

It is also an object of the present invention to provide systems and methods to enable a user to easily register with a micropayment service provider, open a micropayment account with the micropayment service provider, add funds to the account using a variety of payment methods, and use the funds in the account to make micropayment transactions on multiple electronic commerce web sites using multiple currencies and multiple languages, without requiring online communication with a bank or other financial organization to complete the micropayment transaction.

It is also an object of the present invention to provide systems and methods to enable a content provider to accept micropayments from a user's micropayment account without having to grant control of the content to the micropayment service provider or to install a micropayment service provider client on the content provider's web site.

It is also an object of the present invention to provide systems and methods to enable users to manage their micropayment accounts by viewing an instant summary of their accounts, adding funds to their accounts, disputing micropayment transactions recorded in their accounts and receiving refunds for any transactions that were incorrectly charged, and specifying spending limits on their account per transaction, day, week, or month, for micropayment transactions made with their accounts.

It is a further object of the present invention to provide systems and methods that permit a user the convenience to purchase content from different content providers without requiring the user to login or perform a check-out process at each and every content provider web site.

It is also an object of the present invention to provide systems and methods that permit a user to easily access content that the user has already purchased, using an account summary, located at the web page of the micropayment service provider web site, without requiring the user to revisit the content provider's web page for that purchased content.

It is a further object of the present invention to provide systems and methods that enable micropayment service providers to aggregate electronic commerce transactions in a user's micropayment account for payment settlement with vendors using thresholds, either by amount or by time, in order to minimize the cost of each and every electronic commerce transaction.

It is still another further object of the present invention to provide systems and methods that enable each content provider to compensate intellectual property owners, such as authors, publishers and artists, their respective royalty for each and every content item sold.

These and other objects of the present invention are accomplished by providing systems and methods for conducting micropayment transactions easily and seamlessly on multiple electronic commerce web sites to purchase tangible goods, content, or services. The micropayment transactions are transactions in which the payment for the tangible goods, content, or services, is on the order of pennies, a few dollars, or fractions of cents, and much smaller than the typical fee associated with processing credit card transactions. The systems and methods consist of a software solution provided by a micropayment service provider (“MSP”) that enables users to make micropayment transactions online for the purchase of tangible goods, content, or services on electronic commerce web sites using electronic tokens granted by the MSP or by an electronic commerce vendor. Electronic tokens granted by the MSP are electronic authorizations that are accepted at all electronic commerce vendor web sites to allow users to purchase tangible goods, content, or services. Electronic tokens granted by an electronic commerce vendor are intended for user incentives and they are electronic authorizations that are accepted only at the specific electronic commerce vendor site(s) to allow users to purchase tangible goods, content, or services.

In a preferred embodiment, the systems and methods of the present invention involve three main software components: (1) a micropayment server; (2) a micropayment account user interface; and (3) a micropayment vendor API. The micropayment server enables users to easily open a micropayment user account with the MSP to store electronic tokens that may be used to purchase tangible goods, content, or services on electronic commerce vendor web sites that are specified by the MSP as authorizing users to make purchases using their micropayment account. The micropayment user account may be opened by the user online, on a web site maintained by the MSP, or it may be opened through electronic commerce vendor web sites authorized by the MSP or through a customer service representative of the MSP. The micropayment server also maintains a micropayment vendor account for each vendor that accepts electronic tokens as a payment method.

When opening a micropayment user account, a user submits his/her personal information and selects a payment option, such as by providing a credit card number, from which funds will initially be added to the micropayment user account. A user may have several micropayment user accounts, with each account being used for a different currency. The funds may be added in a number of currencies such that a given number of units of a real currency will correspond to an electronic token. For example, users may add $10 to their account to purchase 100 articles for $0.1 each. For each article purchase worth $0.1 the user will be granted an electronic token by the MSP to purchase the article on the content provider's web site. Users may also purchase tangible goods, content, or services using their micropayment user account prior to adding funds to the account. In addition, the MSP may also grant users a signup bonus when they open their user account.

Users may verify their micropayment user account activity by accessing the micropayment account user interface provided on the MSP's web site. Alternatively, users may either download a client to their Internet appliance so that they can have instant access to their account or verify their account activities by contacting a MSP's customer service representative. The user interface enables users to register with the MSP, add funds to their account in multiple currencies and using multiple payment methods, select multiple languages for conducting micropayment transactions online, select spending limits per transaction, day, week, or month, and dispute recorded transactions with the MSP, among other account activities. The micropayment user interface may also be accessed by vendors to manage their vendor accounts with the MSP.

The micropayment vendor API consists of several function calls that are provided to electronic commerce vendors by the MSP so that electronic commerce vendor web sites may interface with the MSP's server while users are purchasing tangible goods, content, or services on the vendor web sites. The API enables vendors to easily provide micropayment services to users without having to install separate client software provided by the MSP. Vendors simply invoke the API function calls when users desiring to purchase items on the vendors' web sites click on links or buttons on the web site corresponding to the item desired for purchase.

For example, when a user desires to purchase a news article on a news web site, the user may simply click on the article's URL to invoke an API function call that will send the news web site information and the article's information to the micropayment server. Upon receiving the news web site information, the micropayment server validates the vendor then displays a “buy” window for the user to confirm or cancel the purchase. The buy window contains the article's information, which may include the title and a brief description of the article being purchased, its price, and whether there are any incentives offered to the user for purchasing the article, among other parameters. Upon confirming the purchase, the micropayment server verifies the user's login information, his/her micropayment account balance, and other security mechanisms. The micropayment server then sends the authorization to the news web site granting the user's access to the article being purchased. Lastly, the news web site displays and downloads the article to the user's Internet appliance. The news web site may also lock down the article to the user purchasing it to prevent the user from copying the article's URL and sending it to other users for them to view the article without having to pay for it. The micropayment server will debit the user's account balance for the price of the news article the user purchased. It will also aggregate all content items sold by that news web site to all users and make a payment via the news content vendor's bank, less a service charge, to the news content vendor when a threshold, either by amount or time, is reached.

In addition, the present systems and methods of the invention provide a back-end interface for e-commerce vendors that includes a security feature for system administrators by which each function of that back-end interface is associated with a security level, or function. The system administrator logins can be given a security profile that enables only the specific sub-set of the possible security functions that they require to perform specific tasks.

To protect the user's private information from being disseminated to participating vendors, the present systems and methods also allow the user an option whether the user will be willing to give out his/her email address to a vendor in order to receive information about the vendor. The system sends an email to the user at the end of the day when the user makes any business transaction and that email will include a hyperlink to a vendor web site, if the user purchased a product from that vendor.

Advantageously, the systems and methods of the present invention provide users the convenience of minimizing interactions between the user's Internet appliance and the vendor's server computer while also reducing the vendor's overhead. Since all purchases or business transactions are done using tokens, very little or no personal sensitive information, such as the user's credit card number, need be transmitted over the Internet. Although information transmitted via the Internet may be encrypted, it is still desirable to eliminate or minimize such transmissions, since they may be intercepted and decrypted.

In addition, since users and the MSP interact directly for registration, purchase and use of electronic tokens and that user's personal information is stored only with the MSP, a user is not required to provide his/her private information to a third party such as a bank or to other vendors. This provides the user with even more security and privacy.

A further benefit of the systems and methods of the present invention is that they do not require that users make payments with their credit card, thus making it unnecessary for users to have a credit card, or for the users and vendors to interact with a bank or other financial institutions to process credit card transactions. Since the online purchases can be handled without credit card transactions, the overhead associated with such transactions can be reduced or eliminated, thus permitting micropayments. Further, since small purchases are paid for in tokens, vendors need not send out an invoice or incur other overhead involved in handling financial transactions with small purchases.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is an illustrative view of the parties and relationships involved in conducting micropayment transactions in accordance with the principles of the present invention;

FIG. 2 is a schematic view of the system and the network environment in which the present invention operates;

FIG. 3 is a schematic view of the software components used in a preferred embodiment of the present invention;

FIG. 4 is a schematic diagram of the micropayment server software constructed in accordance with the principles of the present invention;

FIG. 5 is a flow chart showing steps taken by a user when registering with the MSP to open a micropayment user account;

FIG. 6 is a schematic diagram illustrating exemplary databases within the database server in the MSP including a record of the total aggregated tokens sold and a record of vendors' aggregated sales with vendors' bank accounts for settlement of payments;

FIG. 7 is an illustrative view of a micropayment account user interface screen for user registration;

FIG. 8 is an illustrative view of a micropayment account user interface screen for entering user's personal and billing information;

FIG. 9 is an illustrative view of a micropayment account user interface screen showing a user's account summary and several links for accessing other micropayment account user interface screens;

FIG. 10 is an illustrative view of a micropayment account user interface instant summary screen showing a history of micropayment transactions;

FIG. 11 is an illustrative view of a micropayment account user interface screen for adding funds to the micropayment account;

FIG. 12 is an illustrative view of a micropayment account user interface screen for specifying spending limits for the micropayment account;

FIG. 13 is an illustrative view of a micropayment account user interface screen listing participating vendors that offer electronic tokens as a payment method;

FIG. 14 is an a flow chart for invoking the micropayment vendor API function calls when a content item is being purchased by a user;

FIG. 15 is an illustrative vendor web page listing links of content items that may be purchased by users;

FIG. 16A is an illustrative hyperlink for a content item that may be purchased by a user using electronic tokens;

FIG. 16B is an illustrative Javascript function for starting a micropayment transaction at a vendor web site;

FIG. 17A is an illustrative “buy” window displayed to a user when the user clicks on a link on a vendor web page to purchase a content item;

FIG. 17B is an illustrative “login” window displayed to a user when the user clicks on a link on a vendor web page to purchase a content item and the user has not yet logged in with the micropayment service provider;

FIG. 18A is an illustrative micropayment vendor API function call to be invoked by a vendor web server to initiate a micropayment transaction;

FIG. 18B is an illustrative micropayment vendor API function call to be invoked by a vendor web server to lock down a content item being purchased by a user;

FIG. 19 is an illustrative view of the parameters passed by the micropayment vendor API function calls shown in FIGS. 18A and 18B from the vendor web server to the micropayment web server;

FIG. 20 is a schematic diagram of a vendor's web site that accepts electronic tokens as payment for content items offered for sale on the web site;

FIG. 21 is a schematic diagram showing steps taken by a user when purchasing content items using tokens at multiple vendor web sites;

FIG. 22 is a schematic diagram showing system processes that take place when a user purchases content items using tokens at a vendor web site;

FIG. 23 is a flow chart for purchasing tokens or adding funds to a micropayment account;

FIGS. 24A, 24B, 24C, and 24D are flow charts for purchasing content securely to validate the vendor and content URL address, to preserve the integrity of the transaction data and authentication of the user, and to prevent unauthorized viewing or downloading of content;

FIG. 25 is an illustrative window for adding funds to the user's micropayment account when the account has insufficient funds for purchasing a tangible good, content, or service at a vendor web site;

FIG. 26 is a schematic diagram showing steps taken by a user when purchasing tangible goods or services using tokens at a vendor's web site though a check-out process;

FIG. 27 is a flow chart for purchasing tangible goods at a vendor's web site;

FIG. 28 is a flow chart for aggregating the settlement of payments to vendors by the MSP when settlement thresholds, either by amount or by time, are reached by each vendor; and

FIG. 29A and FIG. 29B are flow charts illustrating the aggregation of royalties to compensate authors, publishers, artists or other intellectual property owners for all vendors selling content and the settlement of payments to content authors, publishers, artists or other intellectual property owners by the MSP when settlement thresholds, either by amount or by time, are reached.

### DETAILED DESCRIPTION OF THE INVENTION

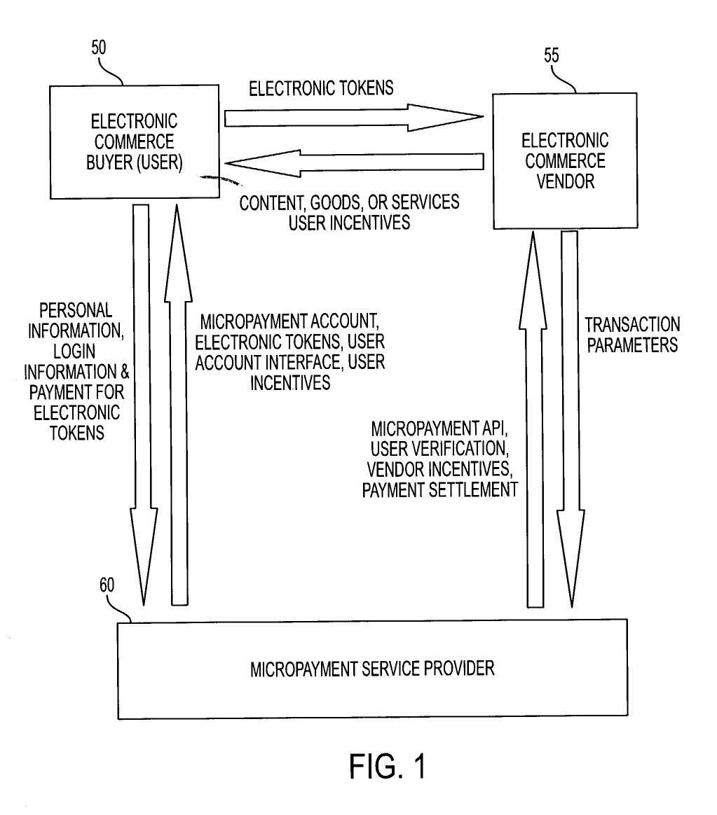

Referring to FIG. 1, an illustrative view of the parties and relationships involved in conducting micropayment transactions in accordance with the principles of the present invention is described. Electronic commerce buyer 50 is a user that visits web sites provided by electronic commerce vendor 55 to purchase tangible goods, content, or services using electronic tokens issued by micropayment service provider 60. Electronic commerce vendor 55 may be a content provider such as The Washington Post, of Washington, D.C., an online store such as Amazon.com, of Seattle, Wash., an online services provider such as Expertcity, Inc., of Santa Barbara, Calif., or an electronic commerce aggregator, such as Yahoo!, Inc., of Sunnyvale, Calif.

Micropayment service provider (“MSP”) 60 provides services to user 50 and electronic commerce vendor 55 to enable them to make micropayment transactions online using electronic tokens granted by MSP 60. Electronic tokens are electronic authorizations granted by MSP 60 that are accepted at electronic commerce vendor 55 to allow user 50 to purchase tangible goods, content, or services using electronic tokens as a payment method. User 50 may purchase electronic tokens directly from electronic commerce vendor 55 or from MSP 60. Electronic tokens purchased by user 50 are recorded in a micropayment user account maintained by MSP 60. User 50 opens the micropayment user account with MSP 60, and in doing so, submits personal information to MSP 60, selects a login ID and password for accessing the account, and selects a number of payment methods available for purchasing electronic tokens with MSP 60. Such payment methods include both online payment with the use of credit cards or automatic debit on personal bank accounts and offline payment using checks, money orders, or purchase orders, among others. In addition, MSP 60 also maintains a micropayment vendor account for vendor 55.

User 50 also may select multiple languages and multiple currencies for purchasing electronic tokens with MSP 60, and spending limits per transaction, day, week, or month, among other options. In a preferred embodiment, MSP 60 opens several micropayment user accounts for user 50, each micropayment user account for a particular currency selected by user 50. For example, user 50 may have a micropayment user account in which all electronic tokens recorded in the account are purchased with U.S. dollars and another micropayment user account in which all electronic tokens recorded in the account are purchased with Japanese Yen.

In addition to micropayment accounts and electronic tokens issued to user 50, MSP 60 also provides user 50 a micropayment account user interface that enables user 50 to manage his/her micropayment accounts. The user interface may be a web site maintained by MSP 60, a client downloaded by user 50 into his/her Internet appliance, an interactive voice response system, or any other offline contact with a customer service representative of MSP 60. The user interface enables user 50 to get a history of past and current transactions on his/her various accounts including links to content items purchased online, add funds to the accounts, dispute transactions recorded on the accounts, and select spending limits for the accounts, among other account activities. The user interface may also be accessed by vendor 55 to manage its micropayment vendor account.

MSP 60 may also issue sign-up bonuses and incentives to user 50 for purchasing tangible goods, content, or services with electronic commerce vendor 55. In a preferred embodiment, sign-up bonuses are electronic tokens issued to user 50 at the time a micropayment user account is opened with MSP 60, while incentives are electronic tokens issued to user 50 at the discretion of MSP 60 and/or vendor 55 to encourage user 50 to purchase more goods, content, or services with vendor 55 using the electronic tokens and services provided by MSP 60. To enable vendor 55 to offer electronic tokens as a payment method to user 50, MSP 60 provides vendor 55 a micropayment API as well as code samples to use as a basis for implementing micropayment services on vendor 55 web site. The micropayment API is described in more detail hereinbelow.

When user 50 clicks on a link corresponding to a tangible good, content item, or service to purchase, the micropayment API function calls are used to send vendor 55's credential information and transactions parameters to MSP 60. Upon receiving vendor 55's credential information which includes a vendor ID assigned to vendor 55 by MSP 60, vendor 55's password and URL, MSP 60 verifies to see if vendor 55 is authorized to sell a tangible good, content item, or service being purchased using electronic tokens. Once vendor 55's credentials are verified, MSP 60 then displays a “buy” window at user 50 Internet appliance. The “buy” window may display various transaction parameters including, for example, the content title, the price and the short description of the content. User 50 may click on a “buy” button that is also displayed on the “buy” window, to proceed with the purchase of the content item from vendor 55. The micropayment API function calls may also be used to lock the content item to user 50 to prevent user 50 from copying the content item's URL and sending it to other users without them having to pay for the content item.

When user 50 clicks on a “buy” button displayed on the “buy” window, MSP 60 verifies user 50's micropayment user account to validate the transaction. Once user 50's account is verified, MSP 60 authorizes vendor 55 to complete the transaction. At no point during the transaction, user 50 is required to submit personal information to vendor 55. In case user 50 is purchasing tangible goods from vendor 55, shipping information for the goods may be submitted to vendor 55 by user 50 or MSP 60, depending on privacy agreements user 50 enters with MSP 60 at the time of opening his/her user account. If user 50 elects not to disclose any shipping information to vendor 55, vendor 55 may have to ship the goods to MSP 60 so that MSP 60 can then ship the goods to user 50. It should be understood by one skilled in the art that other ways to disclose shipping information to vendor 55 may be provided without necessarily having to disclose user 50 personal information to vendor 55.

In a preferred embodiment, when user 50 first logs in with MSP 60 prior to purchasing goods, content, or services online, MSP 60 encrypts user 50 login ID and writes the encrypted user ID into user 50 Internet appliance. The encrypted user ID expires and is erased at a pre-determined time period to prevent any unauthorized user to make micropayment transactions using user 50 Internet Appliance. The login process needs to be done by user 50 only once while user 50 browses various vendor web sites and makes purchases of several items at various web sites before the pre-determined time period for storing user 50 ID into user 50 Internet appliance expires.

MSP 60 may also provide vendor incentives to vendor 55 to encourage vendor 55 to offer electronic tokens as a payment method and to attract more users to sign-up with MSP 60. In addition, MSP 60 settles the payment of user 50, and all other users using electronic tokens to purchase at vendor 55 web site, with vendor 55. The settlement of payment with vendor 55 for user 50 and all other users who have made purchases from vendor 55, takes place only when one of two thresholds is reached. These thresholds are, first, the total amount of purchases of user 50, and all other users, is high enough, and, second, a fixed time interval long enough such as once per month to reduce the frequency of payment settlement. The settlement of payment with the time threshold may not take place if the total amount does not reach the amount threshold. These thresholds may be different from one vendor to another vendor, as they are separately agreed upon between the operator of MSP 60 and each vendor.

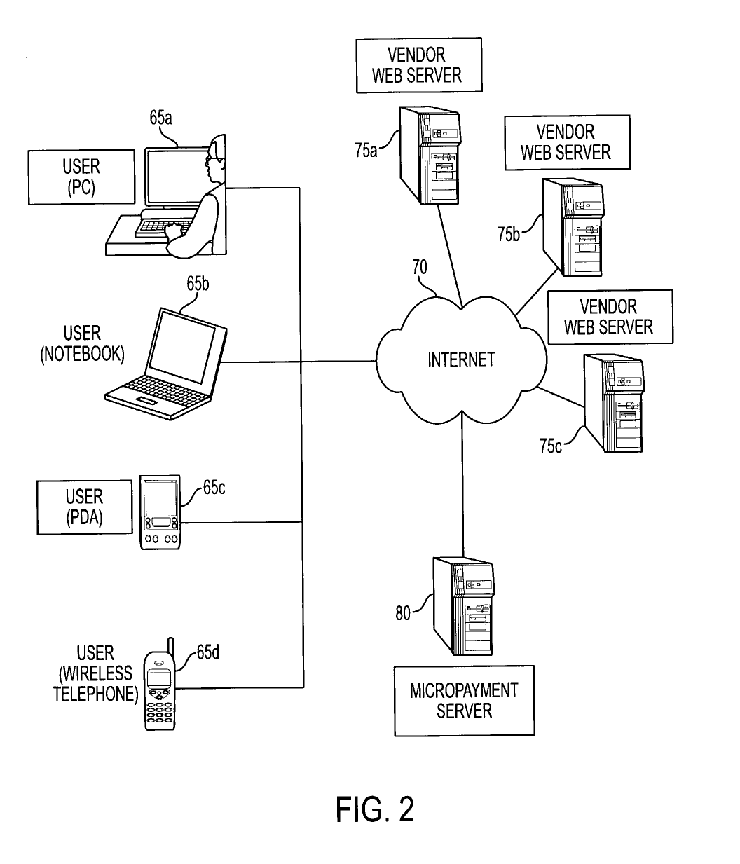

Referring now to FIG. 2, a schematic view of the system and the network environment in which the present invention operates is described. Users 65a-d are connected to network 70, preferably the Internet, for the purpose of purchasing or renting tangible goods, content, or services, from electronic commerce vendors 75a-c. User 65a connects to Internet 70 using a personal computer, user 65b connects to Internet 70 using a notebook computer, user 65c connects to Internet 70 using a personal digital assistant, and user 65d connects to Internet 70 using a wireless device such as a cellular phone. Users 65a-d may also connect to Internet 70 by means of video game consoles and entertainment centers (not shown), or any other Internet appliance capable of connecting to Internet 70.

Users 65a-d purchase tangible goods, content, or services at web pages maintained at electronic commerce vendor web servers 75a-c using electronic tokens granted by micropayment server 80 maintained by MSP 60. Micropayment server 80 provides micropayment services to each and every web server 75a-c who offers electronic tokens as one of the payment options for users 65a-d to purchase tangible goods, content, or services.

Micropayment server 80 also provides users 65a-d with micropayment user accounts to store electronic tokens that may be used to purchase tangible goods, content, or services on vendor web servers 75a-c that authorize users 65a-d to make purchases using their micropayment user accounts. The micropayment user accounts may be opened by users 65a-d online, on a web site maintained by micropayment server 80, or it may be opened through a customer service representative of MSP 60. In addition, micropayment server 80 provides vendors a micropayment vendor account so that each vendor may manage its electronic token transactions.

When users 65a-d select electronic tokens as a payment option when purchasing or renting tangible goods, content, or services at web sites maintained by vendor web servers 75a-c, vendor web servers 75a-c connect to micropayment server 80 through Internet 70 to proceed with the micropayment transaction. The software that resides within micropayment server 80 is invoked by vendor web servers 75a-c through function calls specified in a micropayment API provided by MSP 60. The function calls submit information about the vendors maintaining vendor web sites 75a-c as well as information about the goods, content, or services being purchased to micropayment server 80. The software residing within micropayment server 80 verifies the information submitted by the vendors, checks whether vendors 75a-c are authorized to sell tangible goods, content or services using electronic tokens and checks whether users 65a-d have logged in with micropayment server 80, verifies the login information, and checks whether users 65a-d have enough tokens to complete the transaction. Once all the information is verified, micropayment server 80 sends an authorization back to vendor web servers 75a-c. Upon receiving the authorization, vendor web servers 75a-c send and display a confirmation of the purchases and/or download the content to users 65a-d. This completes the micropayment transaction.

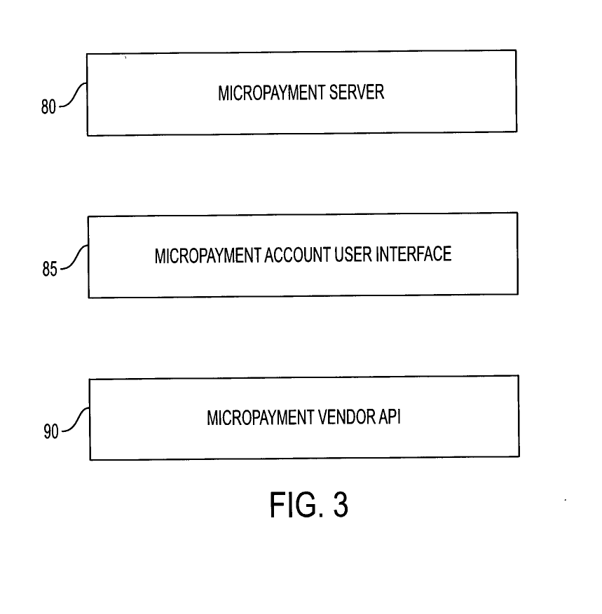

Referring now to FIG. 3, a schematic view of the software components used in a preferred embodiment of the present invention is described. The software components consist of: (1) micropayment server 80; (2) micropayment account user interface 85; and (3) micropayment vendor API 90.

Micropayment server 80 enables users to easily open a micropayment user account with MSP 60 to store electronic tokens that may be used to purchase tangible goods, content, or services on electronic commerce vendor web sites that are specified by MSP 60 as authorizing users to make purchases using their micropayment user account. The micropayment user account may be opened by the users online, on a web site maintained by MSP 60, or it may be opened through a customer service representative of MSP 60. In addition, micropayment server 80 maintains micropayment vendor accounts for each vendor that accepts electronic tokens as a payment method. Micropayment server 80 may be operated by MSP 60, or by a third party Internet services provider or a utility company, such as the telephone company or the electric power company.

When opening their micropayment user account, users submit their personal information as well as a credit card number from which funds will initially be added to their micropayment user account. The funds may be added in a number of currencies such that a given number of units of a real currency will correspond to an electronic token. Users may also purchase tangible goods, content, or services using their micropayment user account prior to adding funds to the account. In addition, MSP 60 may also grant users a signup bonus when they open their micropayment user account. The users' account and personal information are maintained by several databases within micropayment server 80, as described hereinbelow. The databases also manage the settlement of payments among users, vendors, and MSP 60, and contain information on each vendor that accepts tokens as a payment option. The databases also store data corresponding to all transactions between users and vendors, including the users' purchases of electronic tokens and tangible goods, content, or services from the vendors. The databases also store the royalty amounts due to the content authors, publishers, artists or other intellectual property owners.

Micropayment account user interface 85 enables users to verify and manage their micropayment user account activity. User interface 85 may be accessed via MSP 60 web site, or alternatively, users may download a client to their Internet appliance so that they can have instant access to their account or verify their account activities by contacting a customer service representative of MSP 60. User interface 85 enables users to register with MSP 60, add funds to their micropayment account in multiple currencies and using multiple payment methods, select multiple languages for conducting micropayment transactions online, select spending limits per transaction, day, week, or month, and dispute recorded transactions with MSP 60, among other account activities. User interface 85 also enables vendors to manage their micropayment vendor accounts, and the operator of MSP 60 to manage all vendor accounts and user accounts.

Micropayment vendor API 90 consists of several function calls that are provided to electronic commerce vendors by MSP 60 so that electronic commerce vendor web sites may interface with micropayment server 80 while users are purchasing tangible goods, content, or services on the vendor web sites. In a preferred embodiment, micropayment API 90 contains Simple Object Access Protocol (“SOAP”) function calls that are called by vendors to invoke the services provided by MSP 60 when a user clicks on a link corresponding to a content item, tangible good, or service that is available for purchase. The SOAP function calls are included in the web pages designed by the vendors (using ASP/HTML/XML/Java Script/PERL or other technologies), allowing them to use a very simple and efficient mechanism to offer electronic tokens as a payment method without having to invest too much time, money, or implementation effort in redesigning their web site. API 90 enables vendors to easily provide micropayment services to users without having to install separate client software provided by MSP 60. Vendors simply invoke API 90 function calls when users desiring to purchase items on the vendors' web sites click on links or buttons on the web site corresponding to the item desired for purchase.

For example, when a user desires to purchase a news article on a news web site, the user may simply click on the article to invoke a function call of API 90 that will send to micropayment server 80 information regarding the news web site and information related to the news article. The information regarding the news web site includes the news web site vendor ID assigned by MSP 60, vendor password, and the news article URL address. Upon verifying that the news web site is authorized to use electronic tokens for its electronic transaction, micropayment server 80 will display a “buy” window for the user to confirm or cancel the purchase. The buy window may contain information related to the news article, such as the title and a brief description of the article being purchased, its price, as well as whether there are any incentives offered to the user for purchasing the article, among other parameters. When the user clicks the “buy” button on the “buy” window, micropayment server 80 then checks whether the user has logged in with MSP 60. Upon verifying the user's login information, micropayment account balance, and other security mechanisms, micropayment server 80 sends the authorization to the news web site granting user access to the article being purchased. Lastly, the news web site displays and downloads the article to the user's Internet appliance. The news web site may also use another function call of API 90 to lock down the article to the user purchasing it to prevent the user from copying the article's URL and sending it to other users for them to view the article without having to pay for it.

It should be understood by one skilled in the art that micropayment vendor API 90 is provided to a electronic commerce vendor upon the vendor registration with MSP 60 to use the micropayment services provided by MSP 60. At the time of vendor registration, vendors select a vendor ID and password and open a micropayment vendor account with MSP 60 to enable them to offer electronic tokens as a payment method to users registered with MSP 60. Vendors may access their micropayment vendor account by visiting micropayment account user interface 85 maintained by MSP 60 or by contacting by telephone a customer service representative of MSP 60.

I. Micropayment Server

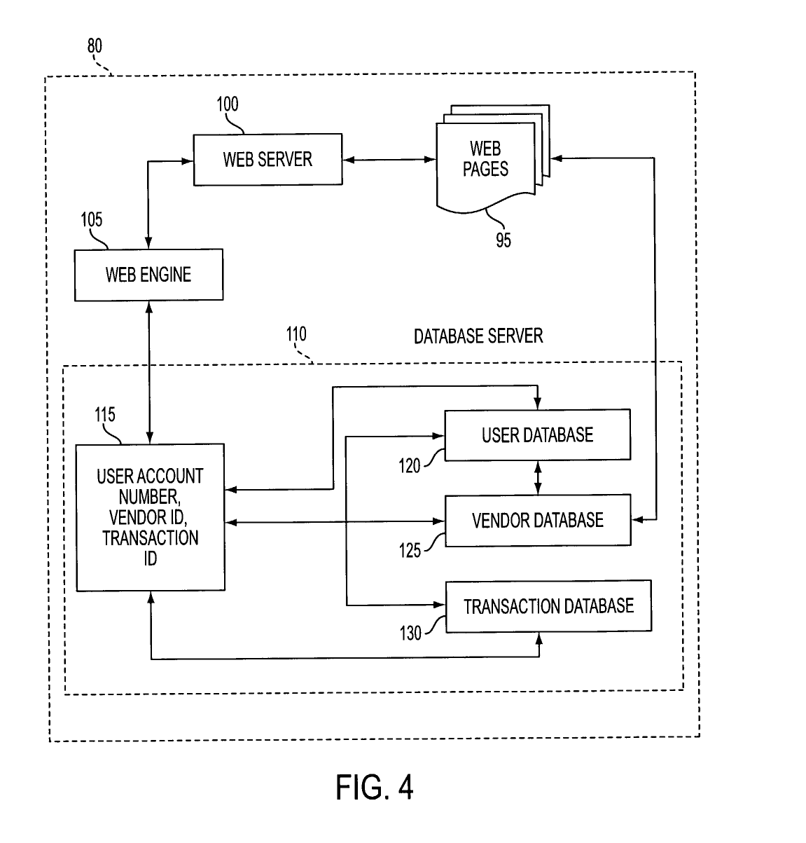

Referring to FIG. 4, a schematic diagram of a micropayment server software constructed in accordance with the principles of the present invention is described. In a preferred embodiment, micropayment server 80 executes web server 100, which communicates across the Internet with numerous web browsers to provide access to web pages 95. Web pages 95 may be pre-defined static web pages, or may include web pages that are dynamically generated, using CGI scripts, servlets, or any other technology that permits a web server to dynamically generate or modify web pages. For example, web pages 95 may be generated to contain a list of vendors who accept tokens as a payment option, extracted from vendor database 125 within database server 110.

Micropayment server 80 also executes web engine 105, which handles electronic tokens, as described in detail hereinbelow. Web engine 105 communicates between web server 100 and database server 110 to handle data on users, users' micropayment accounts, vendor accounts, and other data concerning electronic tokens, users, and vendors.

Micropayment server 80 also executes database server 110, which maintains user account number/vendor ID/transaction ID 115, user database 120, vendor database 125, and transaction database 130. Database server 110 may also manage other databases and tables (not shown) for operating an electronic commerce web site. Database server 110 also manages settlement of payments among users, vendors, and the operator of micropayment server 80 as well as settlement of payments to content authors, publishers, artists, or other intellectual property owners.

User account number/vendor ID/transaction ID 115 contains indexes for the user account number, i.e., user ID for login, vendor ID and transaction ID for immediate access to corresponding user, vendor or transaction ID in user database 120, vendor database 125, and transaction database 130.

User database 120 contains information on each user who registers for a micropayment user account to use tokens as a payment method for purchasing tangible goods, content, or services from a vendor's web site who offers tokens as a payment option. The registration may be done through a vendor web site or directly through web pages of micropayment server 80. Information on each user includes the user's name and other identifying information, account number and any personal information on the user, such as credit card number, bank account information, phone number, address, etc., that the vendor requires. Information on each user also includes the user's preferred method of payment for tokens. Users may register for multiple micropayment user accounts, with each account being transacted on a different currency and different language. For example, users may open a micropayment user account to purchase electronic tokens with U.S. dollars for use in English web sites operated in the U.S.A., and users may open a micropayment user account to purchase electronic tokens with Japanese Yen for use in Japanese web sites operated in Japan.

The systems and methods of the present invention permit a user to purchase electronic tokens either online, using a credit card or by providing user's personal bank account number from which the cost of purchasing tokens can be debited, or offline, in which case the payment method also includes payment by check, money orders, purchase orders, bank wire transfer or cash, as well as payment by a credit card without going through the Internet. It should be understood by one skilled in the art that other payment methods may also be used to purchase electronic tokens.

If the operator of micropayment server 80 is an Internet Service Provider (ISP) or a utility company such as a telephone company or electric power company, the operator may add the cost of the user's token purchases to its monthly ISP charges or utility bills. In this case, a user is given a certain credit line by the ISP or utility company to purchase tangible goods, content, or services, and to allow the user to pay for the purchases later upon receiving the monthly invoice. A user may use more than one credit card or may have multiple payment methods. User database 120 thus contains the user's choice for payment and his/her detailed information.

User database 120 also preferably includes information on the number of electronic tokens available to each user. The available tokens may be in multiple currencies. Tokens may include paid tokens that are usable for all vendors' web sites or incentive tokens, which may or may not have an expiration date and that are usable only at the issuing vendor web site. The systems and methods as invented also permit a group of vendors to issue incentive tokens that are usable only with a particular group of vendors. The systems and methods of the present invention also permit the operator of micropayment server 80 to issue incentive tokens that are usable at any vendor web site who accepts tokens as a payment option. These incentive tokens may or may not have an expiration date. User database 120 may also maintain data on how the user has spent tokens in the past, and whether the user is a “preferred customer” eligible to receive discounts on token purchases and other bonuses, the user's credit and payment status, and any other information that may assist the operator of micropayment server 80 to handle and track each user.

Vendor database 125 contains information on each vendor that accepts tokens as a payment option. Typically, a vendor may accept only one type of currency that is used at the vendor's location. This information includes vendor name, address, authorized personnel to access the micropayment vendor account, vendor bank name/account number, royalty rate, payment settlement thresholds and payment status, and other pertinent information that allows the operator of micropayment server 80 to provide services to each vendor. Vendor database 125 may also include a sales record and content royalty amount for payments to content authors, publishers, artists, or other intellectual property owners, for content sold by vendors.

Transaction database 130 contains all transactions between user and vendors for the user's purchases of tangible goods, content, or services from vendors as well as all transactions between users and the operator or micropayment server 80 for user's purchasing of tokens from micropayment server 80. Transaction database 130 may also include a record of any dispute a user may have and its settlement.

As will be understood by one skilled in the relevant art, the software that is described herein as executing on micropayment server 80 may be distributed among multiple server computers. Similarly, the databases and other records and data maintained by database server 110 may be distributed between multiple database servers executing on multiple micropayment servers.

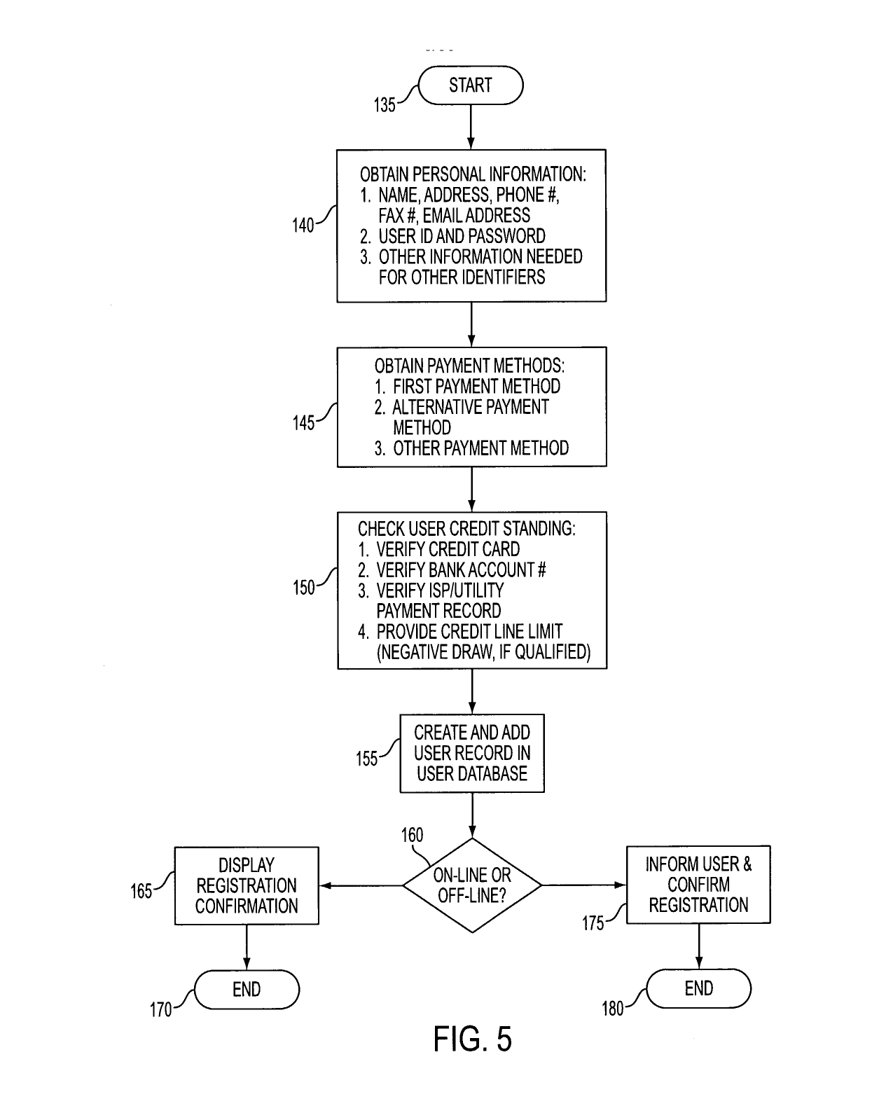

Referring now to FIG. 5, a flow chart showing steps taken by a user when registering with the MSP to open a micropayment user account is described. User 50 may register with MSP 60 directly or through participating vendors, in which case the participating vendors simply pass user 50 registration request to MSP 60. The operator of MSP 60 may provide incentives to each vendor and to groups of vendors to encourage each and every vendor to attract users to register to use tokens as a payment method. To operate an incentive program efficiently, user database 120 and vendor database 125 record association attributes for the relationships between a user with a vendor. The association attributes may be used by the operator of MSP 60 to provide incentives to users and vendors according to their electronic commerce relationship.

At step 140, MSP 60 requests user 50 to provide personal information that may include name, address, phone number, email address, user ID and password to be used for user 50's login to the micropayment account, as well as credit card information and other sensitive information such as user 50's mother's maiden name, pet's name, etc. This sensitive personal information, collectively called “other identifiers,” will be used from time to time by the systems and methods of the present invention to assure proper identification in case MSP 60 finds some irregularity in usage such as unusually large purchases or in case user 50 wishes to change his/her password, spending thresholds, and so forth.

If user 50 is to register offline, user 50 will be asked to fill in a questionnaire form by email, phone, facsimile machine, mail or personally at an office accepting such application. This questionnaire includes the user name, address, phone number, facsimile number, email address, user ID, password and information for other identifiers and other information as with online registration. Some of this information is mandatory which will be so indicated (using for example, red colored fields), and others will be optional (using for example, black colored fields).

MSP 60 will also request user 50 to provide information on how user 50 wishes to pay for the electronic tokens. As shown in step 145, user 50 may purchase tokens or add funds into his/her account using a credit card or a personal bank account for online purchases of tokens. User 50 is asked to provide detailed information regarding his/her credit card, debit card and/or personal bank account. If user 50 prefers, he/she may request the cost for purchasing tokens to be added to his/her monthly ISP invoice or utility invoice, if this billing method is accepted by the operator of MSP 60. Additionally, user 50 may request a certain credit limit allowing user 50 to be invoiced later. The systems and methods of the present invention will record a “negative draw” in user 50's account record for later payment using user 50's ISP, utility monthly invoice, or personal credit line with MSP 60.

At step 150, user 50's credit status is verified either online for credit card or personal bank account payment methods, or offline for invoicing with the monthly ISP or utility invoices. If qualified, user 50 will be given a certain credit limit and he/she will be so informed. Upon receiving user 50's personal information and payment method preferences, micropayment server 80 will create a user record in user database 120 at step 155. Depending on the registration being performed online or offline (step 160), the confirmation and acknowledgment for user 50's registration is displayed at step 165 for a online registration, or user 50 is informed via email, or by other offline method confirming the registration has been completed, as shown in step 175.

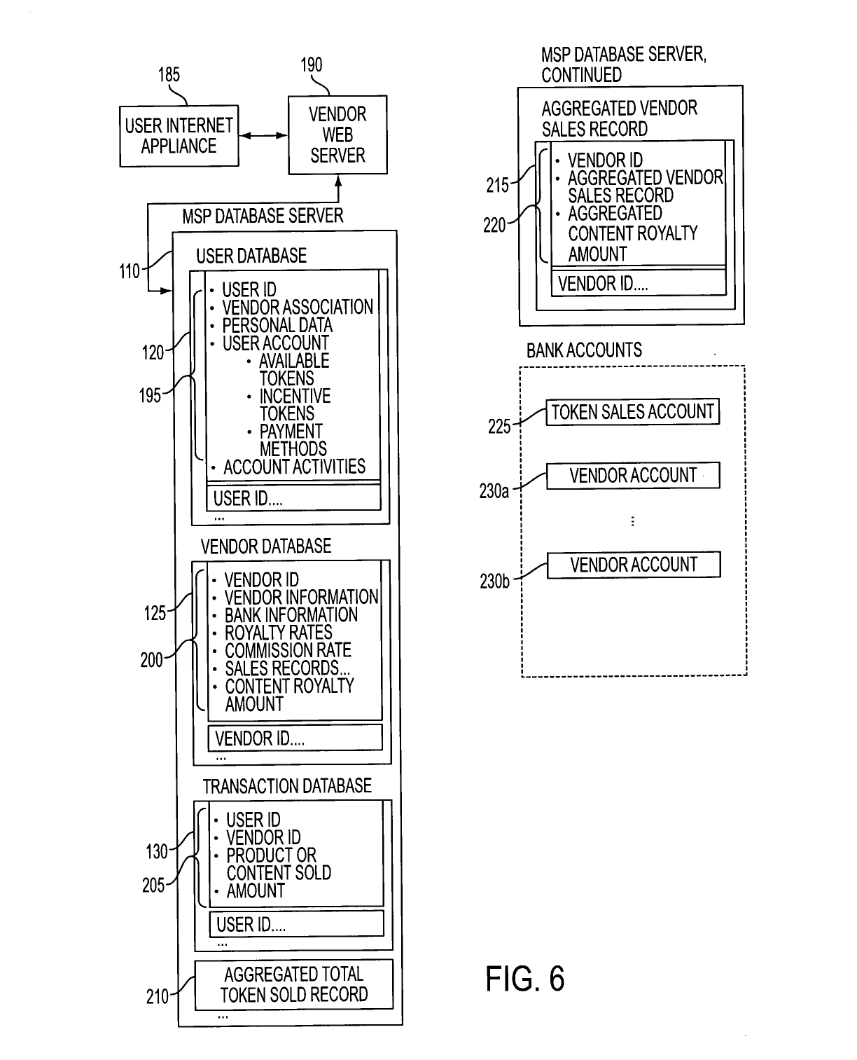

Referring now to FIG. 6, a schematic diagram illustrating exemplary databases within the database server in MSP 60 including a record of the aggregated total tokens sold and a record of aggregated vendors' sales with vendors' bank accounts for settlement of payments is described. User 50 purchases tokens using Internet Appliance 185 either from a vendor web page through vendor web server 190, or directly from MSP 60's web page. The token purchase is then recorded into user record 195 within user database 120 within database server 110. User record 195 contains user 50's login ID and password, user 50's personal data, and the user micropayment account, which includes paid tokens or various incentive tokens and from which vendor the tokens were acquired. User record 195 also includes the approved payment method used for purchasing the tokens (either using credit card, bank account or offline) and the user's detailed information such as credit card name, card number and expiration date or personal bank account number and bank name, etc.

Vendor record 200 within vendor database 125 contains the vendor ID, vendor name, address, phone number, facsimile number, vendor's bank information, and names of person(s) and their personal information who have special security privileges to access vendor record 200. These persons are vendor administrator(s) and they can oversee all transactions that took place at the vendor's web site at any time. Also included in vendor record 200 are royalty rates that are agreed upon between the vendor and the operator of MSP 60. This royalty rate may be designed in a sliding scale and it can be adjusted to encourage marketing and sales initiatives by the vendor. The royalty rate may be different from one vendor to the next vendor. In addition, vendor record 200 also includes commission rates for commissions which the vendor may be entitled to receive from the operator of MSP 60 if user 50 registers to use tokens at MSP 60 through the vendor web site, or if user 50 purchases a large amount of tokens through the vendor web site again, to encourage vendor's marketing initiatives. Furthermore, vendor record 200 also includes all sales records and content royalty amounts due to content authors, publishers, artists, or other intellectual property owners.

Transaction database 130 contains multiple transaction records 205. Each transaction record 205 contains the ID of the user and the ID of the vendor involved in the micropayment transaction as well as the transaction ID which includes content title or product ID, and the amount of the transaction among others. The amount of the transaction is recorded in the currency with which the transaction took place. Transaction record 205 also includes the time and date that the transaction takes place. Each time a micropayment transaction takes place between a user and a vendor or a transaction between a user and micropayment server 80, micropayment server 80 creates user transaction record 205 within transaction database 130.

The micropayment transaction includes user 50 purchasing tokens in a specific currency or purchasing tangible goods, content or services. The amount paid by user 50 for tokens is added to aggregated total token sold record 210. This transaction for purchasing tokens is also recorded in the user account record within user record 195. When a user purchases tangible goods, content or services, the price the user pays at a specific vendor is added to vendor account record 220 for that vendor within the aggregated vendor sales record 215. Similarly, each time a user purchases tangible goods, content or services, the transaction is recorded in user record 195 and vendor record 200. Therefore, aggregated total token sales record 210 and vendor account record 220 for each and every vendor aggregate the micropayment transactions, one for a user purchasing tokens, the other for a user purchasing tangible goods, content or services from a vendor. Furthermore, when a user purchases content, the amount of royalty due to the content author, publisher, or owner may also be recorded in vendor record 200. This royalty amount may also be added to the aggregated content royalty amount in aggregated vendor sales record 220. Aggregated total token sales record 210 and vendor account record 220 will be stored in the currency the vendor uses for the transaction.

When the settlement of payment between the operator of MSP 60 and a vendor is triggered by one of the two events as described above, micropayment server 80 instructs a bank or other financial authority to make online transfer of funds from token sales account 225 in a bank holding money received from sales of tokens, as recorded in aggregated total token sold record 210 for such amount as recorded in aggregated vendor sales record 220 less the aggregated content royalty amount, also recorded in aggregated vendor sales record 220 to each vendor's bank account 230a-b. This settlement of payment between the operator of MSP 60 and a vendor may be done using an offline method such as sending a check to the vendor. The amount recorded in aggregated vendor sales record 220 is then updated to indicate “settled” with the date and time. Similarly, the operator of MSP 60 may make royalty payments to content authors, publishers, artists or other intellectual property owners, triggered by the amount or time threshold.

It is to be noted that the various databases within database server 110, including user database 120, vendor database 125, and transaction database 130 and others described herein are for the purpose of illustrating how user's information, vendor's information, various micropayment transactions and content royalty are recorded in the present systems and methods. One of ordinary skill in the art will appreciate that these databases may be configured differently and that several records either described may be duplicated or those records not described may be added in such a way as to increase the efficiency of the system operation.

In another embodiment of the present invention, several levels of application software security are added in addition to the hardware and software security system typically provided by the Internet service hosting providers. The personal information which MSP 60 requests from users at the time of user registration also includes questions that are not frequently asked of a user, including the user's mother's maiden name, number of sisters and/or brothers, and pet's name, etc. (collectively called, “other identifiers.”) Whenever micropayment server 80 detects unusual activities, it will request the user to answer one of the other identifiers questions. If the answer after a few attempts fails, micropayment server 80 will disconnect the user from the vendor web site.

In addition, the user may set spending thresholds for purchasing products or content, either the total amount per transaction, per session (time period from login to logout), per day, per week or per month. If the threshold is to be reached or exceeded when a micropayment transaction takes place, micropayment server 80 will inform the user that his/her threshold has been reached and requests the user to reduce the user's purchases or rejects the completion of the micropayment transaction. The user may change the threshold by logging into MSP 60. However, the user will be required to successfully answer one of the questions in the other identifiers for the proper identification of the user. The threshold settings may apply to all participating vendors.

The user may also set his/her spending threshold described to be applied to specific vendors only. If this is done, purchases of tangible goods, content, or services will be limited to one of the specific vendors listed. Also, the user will not be able to access and purchase any products or content from vendors that he/she does not specify. This feature allows parents, for example, to prevent children from purchasing undesirable products or content from vendors offering products or content not suitable for them.

Micropayment server 80 may also automatically send email to the user at the end of the day regarding any micropayment transaction that takes place by the user at any vendor web site. This email informs the user that there has been at least one micropayment transaction that took place in the day. The user may access his/her account record by logging in at MSP 60 to view the detail of the micropayment transactions. This includes vendor names, product name, price, total amount with date and time of purchase. In addition, user account interface 85 includes a link that allows the user to immediately disable any micropayment transaction from the user. This minimizes the potential damages to a user when his/her user ID and password are stolen. The user may re-activate his/her account by logging into MSP 60 through a link on user account interface 85 called “contact us.”

If a user's ID and password are stolen and the user did not set thresholds as described above and the user did not check his/her email for awhile, the maximum loss to the user will be the total amount of tokens that are available in the user's account.

II. Micropayment Account User Interface

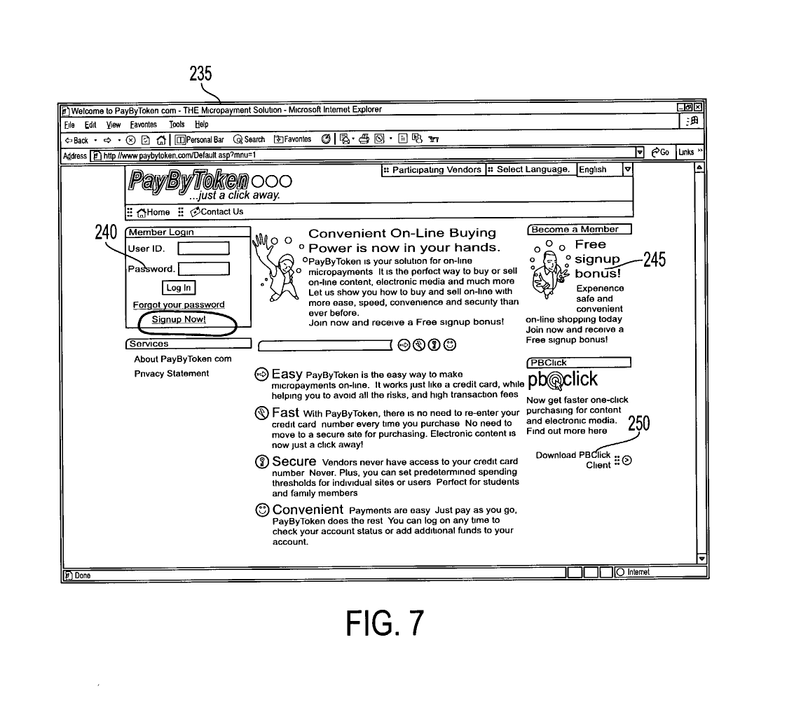

Referring to FIG. 7, an illustrative view of a micropayment account user interface screen for user registration is described. User interface screen 235 shows a user interface web page hosted by a micropayment service provider, such as MSP 60. The user interface web page displays information about the micropayment services offered by MSP 60 to users. Users may sign up with MSP 60 by clicking on a hyperlink on “members login” area 240. Members login area 240 may also be used by users who are already registered with MSP 60 to access information on their micropayment account. In addition, the web page displays information on area 245 about a sign-up bonus that is offered to users at the time they register with MSP 60. The sign-up bonus consists of sign-up tokens that may be used by the users to purchase tangible goods, content, or services on participating vendor web sites.

Users may download a user interface client by clicking on button 250 provided in the web page. The user interface client is downloaded to a user's Internet appliance so that the user may easily access information about his/her micropayment account without having to access the user interface web page or contact a customer service representative by telephone.

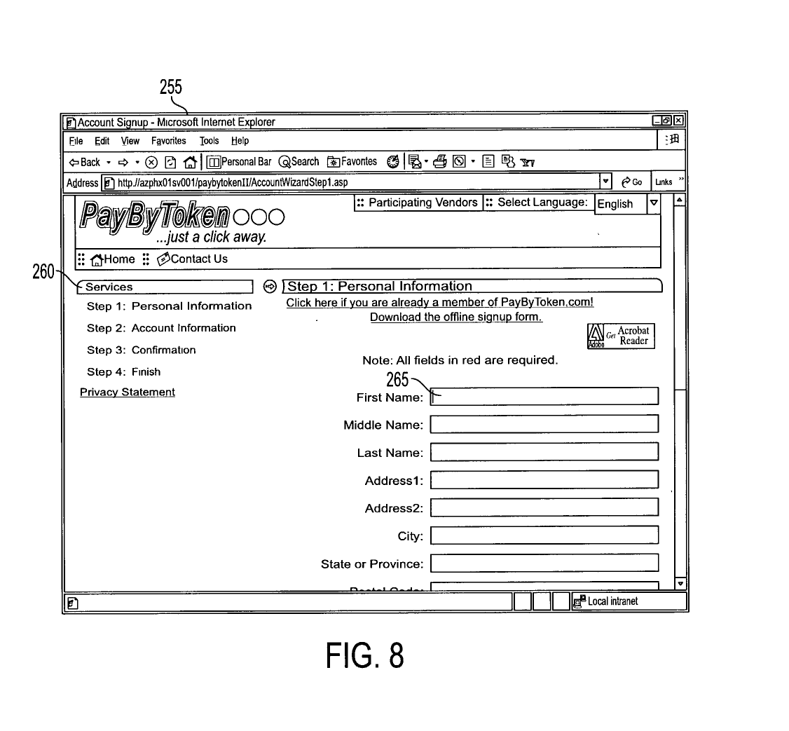

Referring now to FIG. 8, an illustrative view of a micropayment account user interface screen for entering user's personal and billing information is described. User interface screen 255 is a screen of the user interface web page that is accessed by the user after the user selects a hyperlink, “Signup Now!” in the Member Login area 240 (FIG. 7). The web page lists steps 260 that the user needs to follow to complete his/her registration with MSP 60, including submitting user's personal information and billing information in fields 265. The user's personal information may include the user's name and address, while the user's billing information may include the user's preferred payment options for purchasing electronic tokens. The payment options include credit cards, automatic debit on the user's personal bank accounts, checks and electronic checks, money orders, purchase orders, among others.

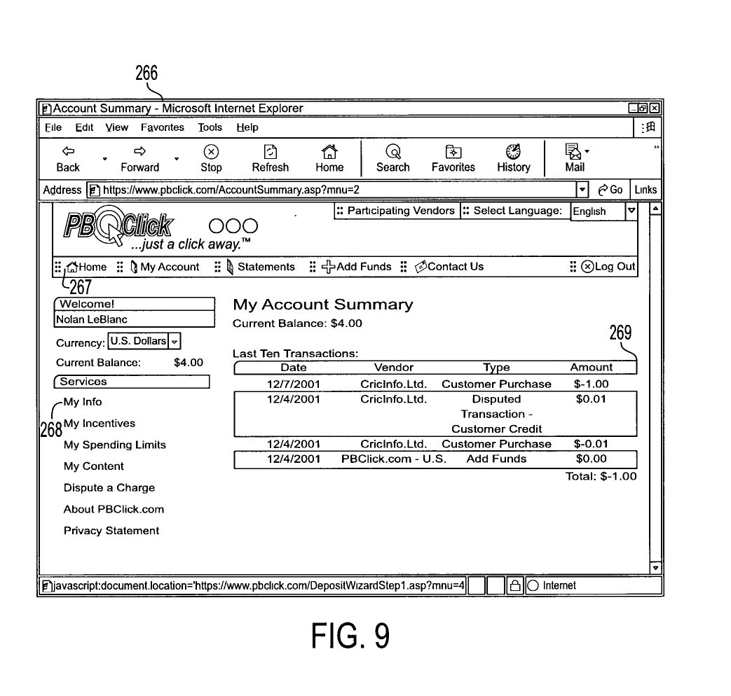

Referring now to FIG. 9, an illustrative view of a micropayment account user interface screen showing a history of micropayment transactions is described. User interface screen 266 shows a list of the most recent 10 transactions performed by the user using his/her micropayment account in field 269. Screen 266 allows the user to access his/her account statement and add funds to his/her account, and provides a means to contact the operator of MSP 60, as displayed in field 267. The screen also lists other services in field 268 that include links to access user information, incentives, spending limits, the content item the user purchased and a link to dispute a charge.

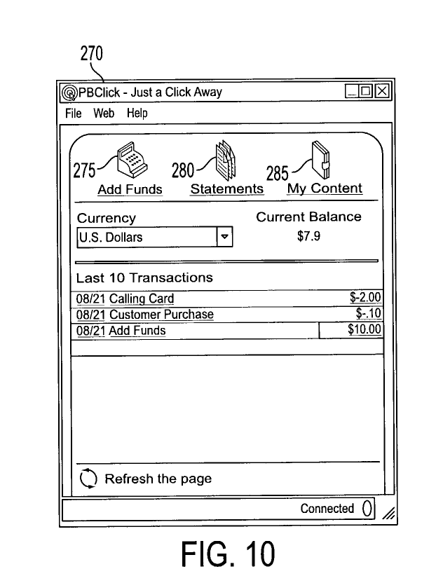

Referring now to FIG. 10, an illustrative view of a micropayment account user interface screen which is displayed when a user clicks the user interface client previously downloaded to the user's Internet appliance is described. User interface screen 270 shows a history of micropayment transactions, displaying a list of the most recent 10 transactions performed by the user using his/her micropayment account. Screen 270 also enables the user to add funds to his/her account at link 275, view account statements at link 280, and access a screen showing a detailed history of content items the user purchased, at link 285. A user can also access the same screen when he/she clicks on the hyperlink “My Content” in field 268 in FIG. 9. The “My Content” hyperlink displays a list of all content items the user purchased using his/her micropayment account. Similar to each content item displayed in screen 270, each content item displayed in the “My Content” hyperlink at link 285 includes the date, the title of the content item, and a URL link allowing the user to re-visit and access the content item he/she already purchased, without requiring him/her to go to the content web site again, if the content item has not expired. The content provider may choose to have the content item expire based on time or number of re-visits.

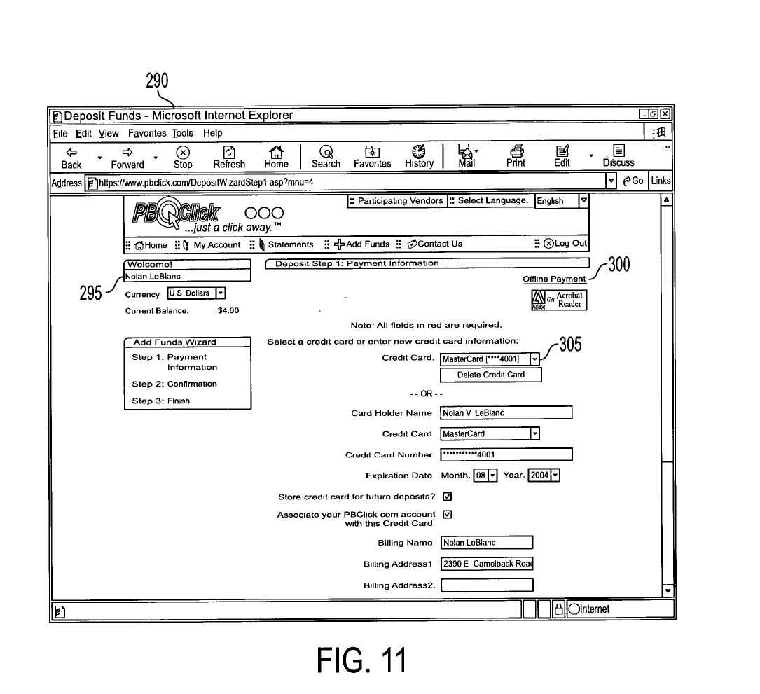

Referring now to FIG. 11, an illustrative view of a micropayment account user interface screen for adding funds to the micropayment account is described. User interface screen 290 may be accessed by the user when clicking on link 275 shown in FIG. 10 or clicking on hyperlink “Add Funds” in field 267 in FIG. 9. Screen 290 enables the user to select the real currency for purchasing electronic tokens at field 295, such as U.S. dollars, Japanese Yen, Brazilian Real, among others. Screen 290 also enables the user to choose between purchasing electronic tokens by making an offline payment (link 300) or by making an online payment (area 305). If a user desires to make an offline payment, then link 300 opens a form that may be filled by the user listing his/her preferred offline payment method, such as payment by check, money orders, purchase orders, or through a customer service representative, among others. For online payment, a user may select the credit card number entered at the time of registration with MSP 60, or may enter a new credit card number. Alternatively, a user may select to automatically debit his/her personal bank accounts or other online financial account.

It will be understood by one skilled in the art that a user is not required to purchase electronic tokens, i.e., add funds to an account, prior to making a micropayment purchase at a participating vendor web site. A user may incur a negative draw on an account for later payment via the user's ISP, utility monthly invoice, or their personal credit line with MSP 60.

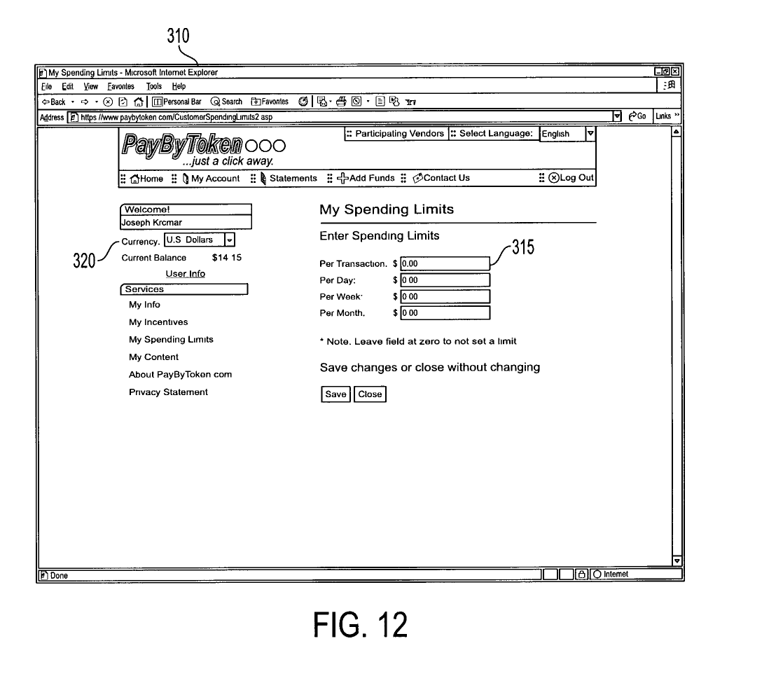

Referring now to FIG. 12, an illustrative view of a micropayment account user interface screen for specifying spending limits for the micropayment account is described. User interface screen 310 may be accessed by the user when clicking at hyperlink “My Spending Limits” in field 268 in FIG. 9. Screen 310 enables the user to specify spending limits on his/her micropayment accounts per transaction, per day, per week, or per month, by filling out fields 315. The user may specify the spending limits by selecting a number of real currencies at field 320, such as U.S. dollars, Japanese Yen, among others.

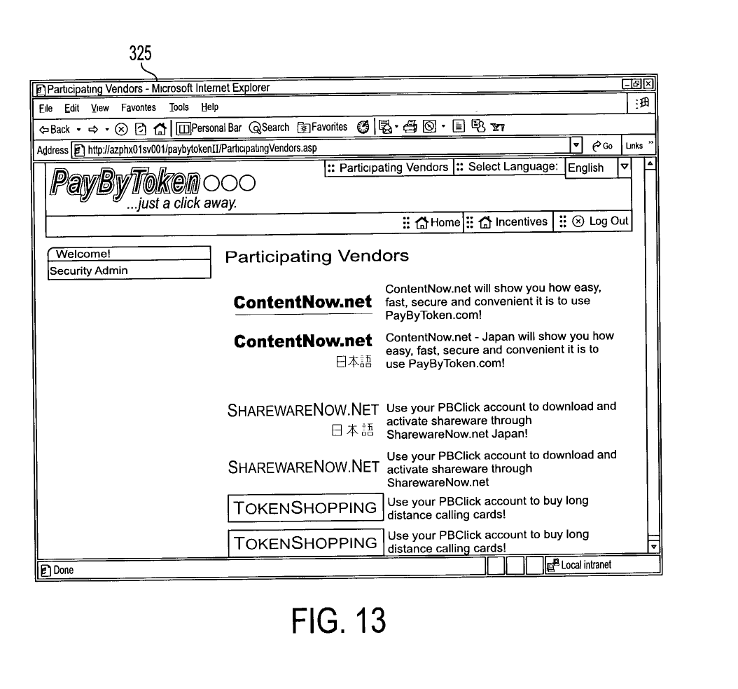

Referring now to FIG. 13, an illustrative view of a micropayment account user interface screen listing participating vendors that offer electronic tokens as a payment method is described. User interface screen 325 shows a list of vendors that have registered with MSP 60 to offer electronic tokens as a payment method to users. Users may go to the participating vendor web sites directly, or by clicking on any one of the links displayed on screen 325. Alternatively, users may get a list of the participating vendors by calling a customer service representative of their MSP.

III. Micropayment Vendor API

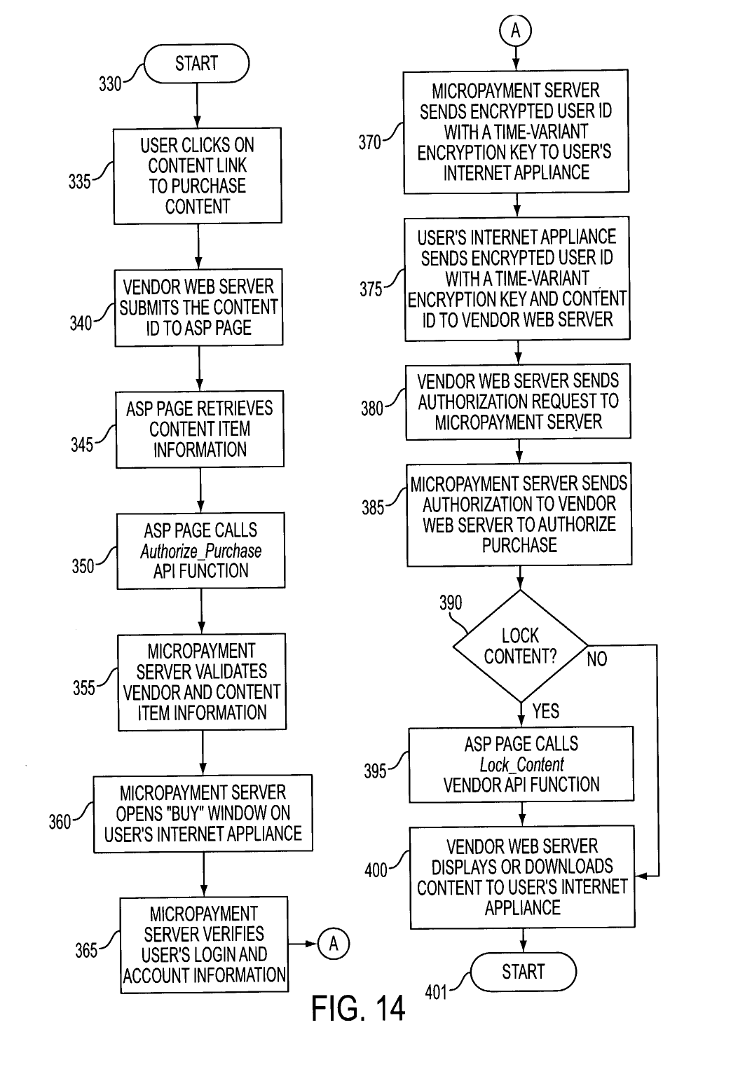

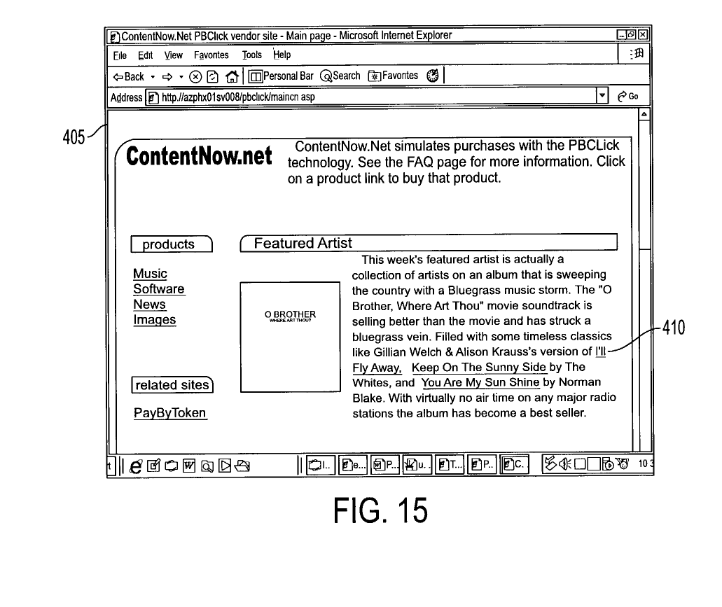

Referring to FIG. 14, a flow chart for invoking the micropayment vendor API function calls when a content item is being purchased by a user is described. The content item is accessible by a hyperlink on a vendor's web page, such as web page 405, shown in FIG. 15. At step 335, the user clicks on the hyperlink to purchase the content item, such as hyperlink 410 on web page 405 to purchase the digital song entitled “I'll Fly Away.”

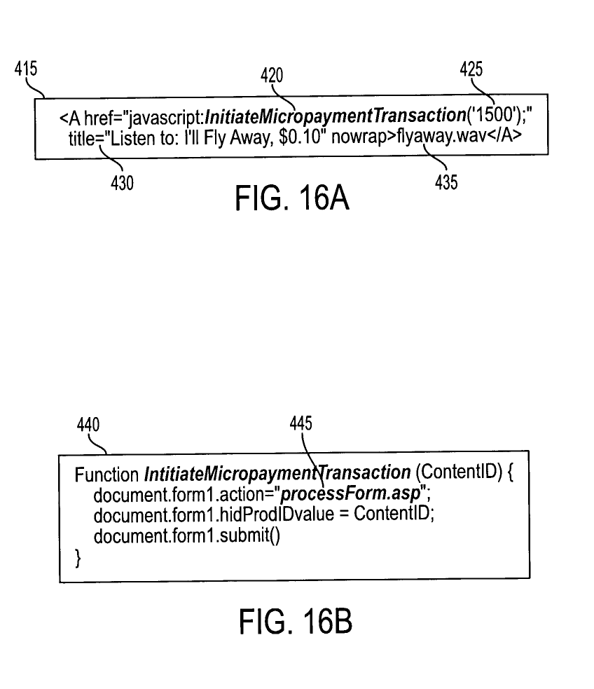

Referring now to FIG. 16A, an illustrative hyperlink for a content item that may be purchased by a user using electronic tokens is described. Hyperlink 415 is a link to a digital song entitled “I'll Fly Away” that may be purchased by the user for $0.10 using electronic tokens. When the user moves the mouse cursor of a personal or notebook computer over hyperlink 415, title 430 showing the name and the price of the song are displayed to the user. Alternatively, title 430 may be displayed to the user when the user taps the link on a personal digital assistant, selects a key on a cellular phone keypad, or performs a similar activity on another Internet appliance.

When the user clicks on hyperlink 415, the vendor web server maintaining the vendor's web page where the content item is listed invokes Javascript function 420 to initiate the micropayment transaction between the vendor and the user through a micropayment service provider such as MSP 60, hosting micropayment server 80. Javascript function 420 has parameter 425 to indicate the “content ID” of the content item being purchased. The content ID of the “I'll Fly Away” song in this case is 1500. Hyperlink 415 also contains audio file 435 corresponding to the song being purchased by the user.

Referring now to FIG. 16B, an illustrative Javascript function for starting a micropayment transaction at a vendor web site is described. Javascript function 440 is used to submit Content ID parameter 425 to Application Server Page (ASP) 445 generated by the vendor web server. An ASP page is a dynamic web page generated by a program or script in the vendor web server to collect information from different sources, such as the ASP page itself or a database. ASP 445 may be an HTML, XML (or other technology) page that is used to retrieve information about the content item being purchased from ASP 445 or from a database maintained by the vendor web server. The information retrieved by ASP 445 includes information about the content item such as its title, price, and description, expiration by time or number of access, as well as information about the vendor, among others.

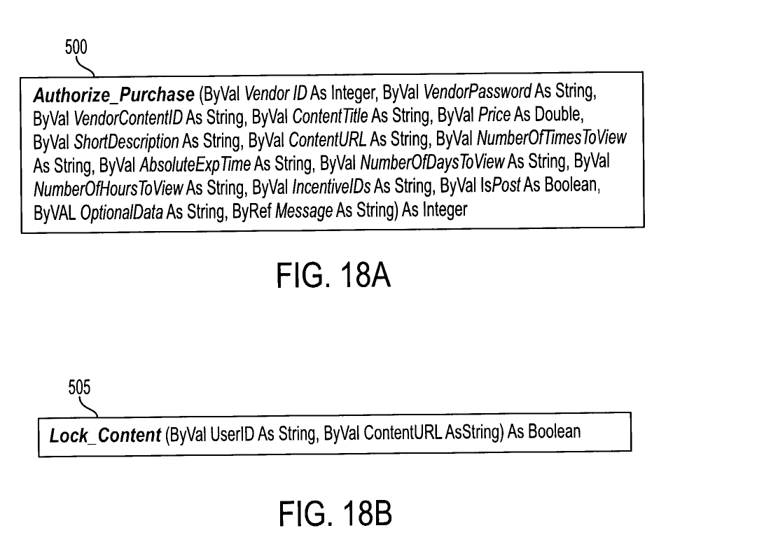

Referring now to FIGS., 14, 16A, and 16B, at step 340, the vendor web server submits content ID parameter 425 to ASP 445, and at step 345, ASP 445 retrieves information about the content. The information retrieved is submitted at step 350 to MSP 60 via the Simple Object Access Protocol (SOAP) by calling micropayment vendor API function call 500, shown in FIG. 18A. Function call 500 is used to pass information about the vendor and the content item being purchased from the vendor web server to micropayment server 80. At step 355, micropayment server 80 validates the vendor and content item information to see if the vendor is among the participating vendors authorized to sell tangible goods, content, or services to users using electronic tokens as a payment method.

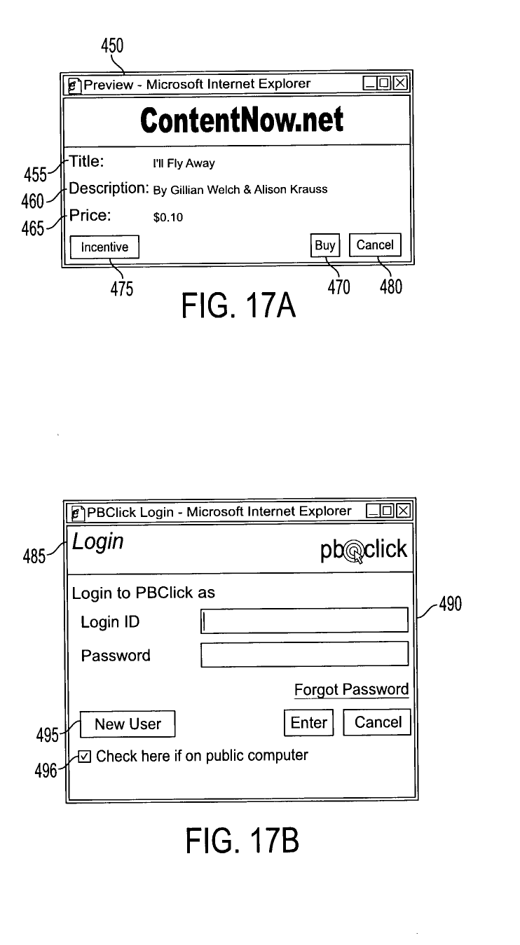

Micropayment server 80 will then create a transaction ID for the transaction data, record both the transaction ID and transaction data in transaction database 130 then send the function and transaction ID to the user's Internet appliance. This function opens a new window on the user's Internet appliance and sends the transaction ID back to micropayment server 80. At step 360, the micropayment server then displays transaction data on a “buy” window at the user's Internet appliance. An illustrative “buy” window is shown on FIG. 17A. “Buy” window 450 contains content title 455, an optional brief description of the content 460, and content price 465 with buttons such as “Buy” (470), “Incentive” (475), and “Cancel” (480).

“Buy” button 470 may be selected by the user to purchase the content item using electronic tokens stored in the user's micropayment account. “Incentive” button 475 may be selected by the user to purchase the content item using an incentive token that has been grated to the user either by MSP 60 or by the vendor. If the user clicks on “Incentive” button 475, the user will be asked to enter the appropriate incentive code corresponding to the incentive token. MSP 60 will then validate the incentive code given by the user. In case the incentive code and other transaction data are not valid, MSP 60 will display an error message at the user's Internet appliance.

Referring back to FIG. 14, at step 365, MSP 60 verifies whether the user has already logged into his/her micropayment account with MSP 60. If the user has not yet logged in with MSP 60, MSP 60 will ask the user to login by filling out fields 490 at login window 485 (shown in FIG. 17B) or to register with MSP 60 by clicking on button 495 at login window 485, if the user has not already done so. This login process needs to be done by the user only once while the user browses various vendor web sites and makes purchases of several items at various vendor web sites. When the user first logs into MSP 60, MSP 60 writes the encrypted user ID into the user's Internet appliance, which will expire and be erased at a pre-determined time period to prevent an unauthorized user from purchasing items using the user's Internet appliance. Login window 485 also displays box 496 which is automatically checked by default indicating that the Internet appliance the user is using is a public computer so that the user is required to log in with MSP 60 each and every time he/she makes purchases of an item at various vendor web sites. This is because MSP 60 will not write the encrypted user ID into the user's Internet appliance. If the user unchecks box 496, then he/she is required to log in with MSP 60 only once, as described above.

After the user has logged in with MSP 60, MSP 60 checks whether the user's spending limit threshold has been reached. If not, MSP 60 checks whether the user's micropayment account contains a sufficient number of tokens to make the purchase of the content item. If the user has logged in MSP 60 and he/she has enough tokens, micropayment server 80 encrypts the user ID with a time variant encryption key, opens a blank window on the user's Internet appliance with the URL address corresponding to the content item being purchased, and submits the encrypted user ID and content ID to the user's Internet appliance at step 370.

The time-variant encryption ID is used to prevent unauthorized viewing, listening, or downloading of content items from a vendor web page. The time-variant encryption ID changes at pre-determined time periods and it is used by micropayment server 80 to validate the user before sending the authorization to a vendor web server to authorize the purchase. This way a user will not be able to purchase a content item and send the URL corresponding to the content item to a friend so that the friend can view, listen to, or download the content item freely. For example, if the user purchases a song and later e-mails the song's URL to a friend, the friend will not be able to click on a URL because the time-variant encryption user ID has already changed.

At step 375, the user's Internet appliance sends the encrypted user ID with the time-variant encryption key to the vendor web server. Upon receiving the encrypted user ID with the time-variant encryption key and content ID, the vendor web server will request an authorization from MSP 60 at step 380 so that the user's purchase may be authorized. At step 385, micropayment server 80 sends the authorization to the vendor web server to authorize the purchase.

At step 390, the micropayment server checks to see if the vendor web server has previously decided whether the content item being purchased is to be locked to the user purchasing the content item so that no other user may access the content item without going through a similar micropayment transaction. If the vendor web server has previously decided to lock the content item being purchased, then at step 395, the vendor web server will invoke micropayment vendor API function call “Lock_Content” 505 shown in FIG. 18B to redirect the encrypted user ID and content URL address to MSP 60. MSP 60 will then decrypt the user ID and check whether the user has access to the content URL address. For a user to have access requires that the time-variant encryption user ID is valid, paid for the content item, the time period for which the content item is valid has not expired, and the number of accesses also has not been exceeded.

If the user has access to the content item, then MSP 60 authorizes the vendor web server to display or download the content to the user's Internet appliance at step 400. In case the user doesn't have access to the content item, MSP 60 may request the user to purchase the content again. The above content locking process prevents the vendor web server from displaying or downloading the content item even if the user copies the content URL address and encrypted user ID and sends them to a third party, because the time-variant encrypted user ID will have changed. If the page at the content URL address does not have a “lock content” option, then the vendor web server will display or download the content item to the user's Internet appliance.

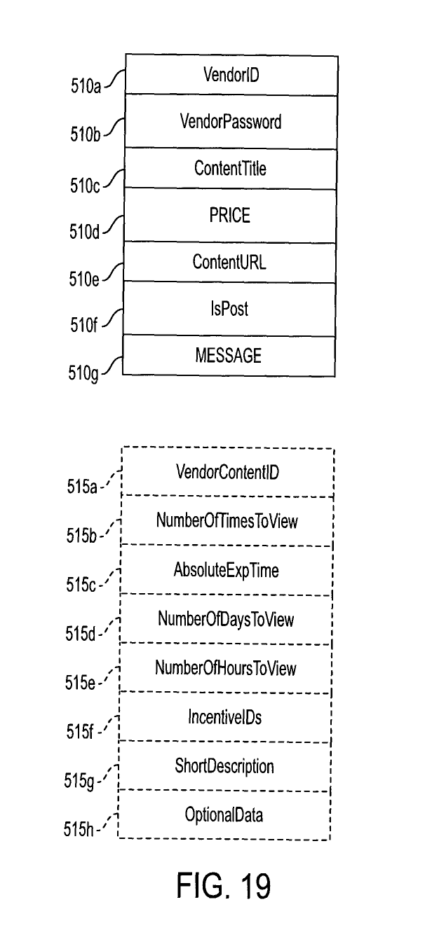

Referring now to FIG. 19, a schematic view of the parameters of the micropayment vendor API function calls shown in FIGS. 18A and 18B is described. API function call 500 submits required parameters 510a-g to micropayment server 80, including: (1) VendorID (510a); (2) VendorPassword (510b); (3) ContentTitle (510c); (4) Price (510d); (5) ContentURL (510e); (6) IsPost (510f); and (7) Message (510g).

VendorID parameter 510a is a unique vendor identification number assigned to each participating vendor authorized to sell items online to users using electronic tokens issued by MSP 60 as a payment option. VendorPassword parameter 510b is the password that was chosen by the vendor at the time the vendor registered with MSP 60 to use MSP 60's micropayment services. The vendor may change its password anytime by visiting a web site maintained by MSP 60 containing information on the vendor's micropayment account.

ContentTitle parameter 510c is the title the vendor would like to display for the content at the “buy” window opened to the user. Price parameter 510d lists the price the vendor would like to charge for the content. The price of the content also appears on the “buy” window displayed to the user. Content URL parameter 510e is the ContentURL the user will be redirected to after purchasing the content item. This parameter is also used to track if the user has already purchased the content item and should, therefore, be unique. IsPost parameter 510f tells micropayment server 80 whether to use a “FormPost” or a “GetAction” on the content to which the user is redirected. Preferably, IsPost is set to FormPost so that the content parameters are not exposed to others. Lastly, Message parameter 5log is a variable that contains the response of micropayment server 80 conveying whether the micropayment transaction for the purchase of the content item has been authorized or not.

Additionally, API function call 500 may submit optional parameters 515a-h to micropayment server 80, including: (1) VendorContentID (515a); (2) NumberOfTimesToView (515b); (3) AbsoluteExpTime (515c); (4) NumberOfDaysToView (515d); (5) NumberOfHoursToView (515e); (6) IncentiveIDs (515f); (7) ShortDescription (515g); and (8) OptionalData (515h).

VendorContentID optional parameter 515a is an ID that may be sent back to the vendor web server when a micropayment transaction is complete. This parameter can also be used by a vendor for internal tracking purposes. NumberOfTimesToView optional parameter 515b specifies the number of times that the user purchasing the content item is authorized to view the content item. AbsoluteExpTime optional parameter 515c lists the date and the time in GMT that a content item should expire. NumberOfDaysToView optional parameter 515d lists the number of days for which content item is valid, and NumberOfHoursToView optional parameter 515e lists the number of hours for which the content item is valid.

IncentiveIDs optional parameter 515f is a string containing all of the valid IncentiveIDs associated with the content item. When all valid incentive tokens may be used against the content item, this parameter is left blank. If the parameter is set to “−1,” then no incentive tokens may be used with this content. ShortDescription optional parameter 515g is a short description of the content. This parameter also may be shown on the “buy” window displayed to the user. Lastly, OptionalData optional parameter 515h may be used for any optional data that the vendor would like to pass through to the content URL for internal tracking purposes.

It should be understood by one skilled in the art that additional parameters may be used by MSP 60 and the vendor web server to complete a micropayment transaction for the purchase of tangible goods, content, or services. It should also be understood by one skilled in the art that the micropayment vendor API may be implemented using different technologies other than the SOAP calls illustrated hereinabove.

IV. Micropayment Transaction Flow Between Users, Vendors, and the Micropayment Service Provider

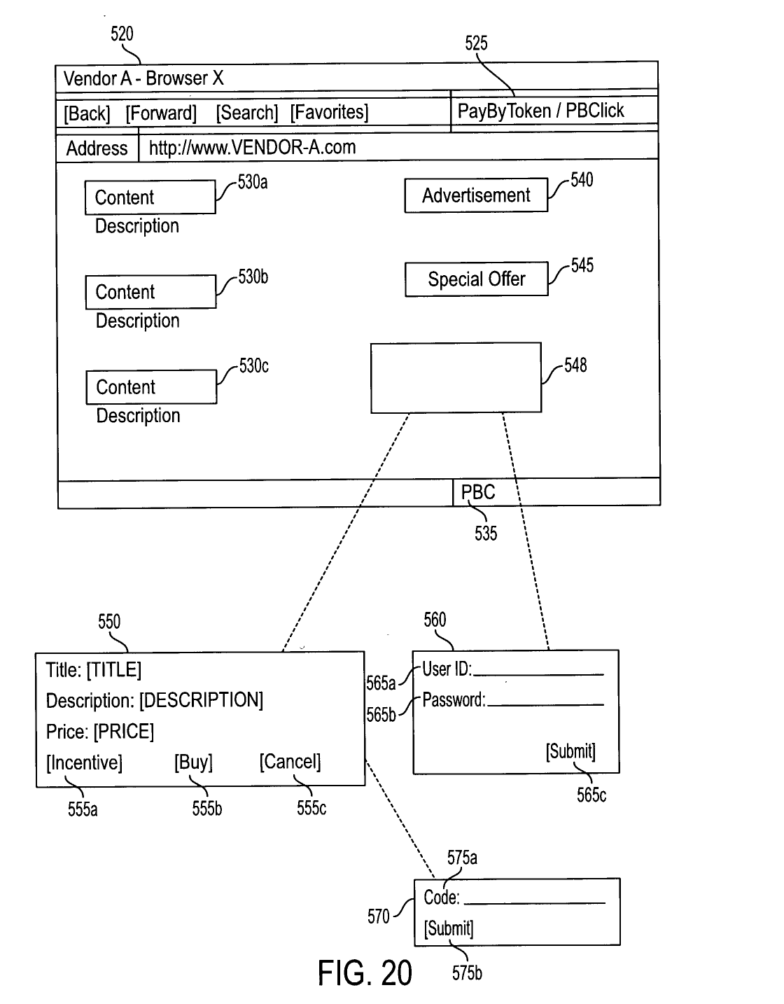

Referring to FIG. 20, a schematic diagram of a vendor's web site that accepts electronic tokens as payment for content items offered for sale on the web site is described. As will be understood by one skilled in the relevant art, the appearance of web site 520 in FIG. 19 simply demonstrates key components that may be displayed at a content vendor's web site. The appearance of web site 520 is subject to artistic design by each and every vendor.

The availability of tokens as a payment option for content is displayed by icon 525. Several content items are available for purchase, including content items 530a-c. Web site 520 also may include promotional windows 540 and 545, and various pop-up windows 548, as described hereinbelow. If a user clicks on one of the content items 530a-c, the systems and methods of the present invention make vendor web site 520 display pop up “buy” window 550, which contains the title, an optional brief description of the content item, and the price of the content item. Window 530 also may include “Incentive” button 555a, “Buy” button 555b and “Cancel” button 555c. If the user decides to purchase the content item, he/she can simply click on “Buy” button 555b. The user may decide not to purchase the selected content, in which case the user can select to click on “Cancel” button 555c.

As mentioned earlier, the systems and methods of the present invention permit each vendor and the operator of MSP 60 the freedom to offer incentive tokens to users. Pop-up window 550 contains “Incentive” button 555a, allowing the user to pay for the content item using incentive tokens he/she may have in his/her micropayment account with MSP 60. In case the user decides to pay for the content item using incentive tokens, he/she can click on “Incentive” button 555a and pop-up window 570 will be displayed in which the system requests the user to enter the code assigned for the incentive tokens in field 575aNote that there may be several incentive tokens offered by each and every vendor as well as the operator of MSP 60 and these incentive tokens may have certain restrictions such as an expiration date. Therefore, the present systems and methods, assign a code for each type of incentive token that is issued by each vendor and the operator of MSP 60. This permits the system to identify the type of incentive tokens and the proper management of the incentive tokens by a user and the operator of MSP 60. After the user clicks on “Buy” button 555b or enters the incentive code and clicks the “Submit” button 575b, the system performs one of the following three processes:

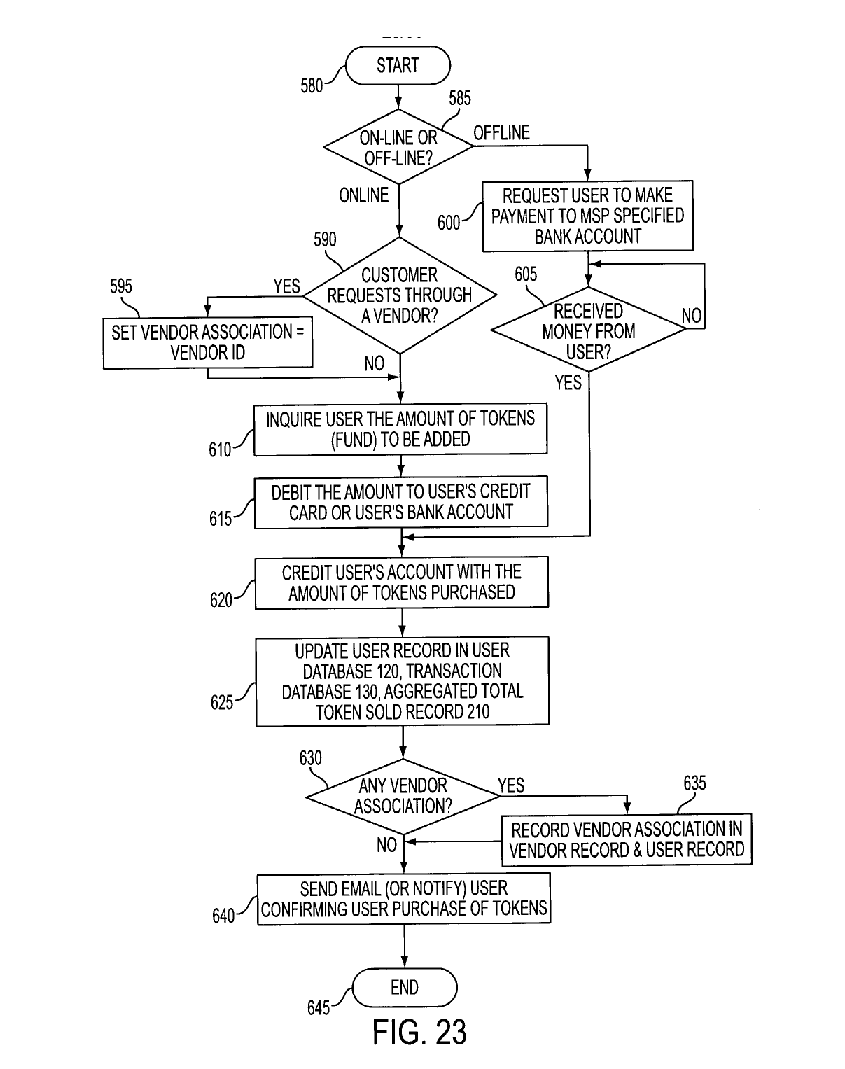

Case I: If the user previously logged-in with MSP 60 (not shown), MSP 60 will retrieve the user ID from the user's Internet appliance (not shown) and then immediately access user record 195 in user database 120 (FIG. 6) and check whether the user has enough tokens in his/her micropayment account. If yes, MSP 60 will authorize the vendor to sell and to display the published content item or download the selected content item. Therefore, the present systems and methods of the present invention provide users the convenience of purchasing content from vendor web sites without requiring users to log-in or check-out at the vendor web sites. If the user does not have enough tokens, MSP 60 will display a message (not shown) informing the user that he/she does not have enough tokens in his/her account to make the purchase and advise the user to purchase more tokens (add funds) to his/her account, as described in greater detail with respect to FIG. 23.

Case II: If the user did not log-in with MSP 60, the system causes vendor web site 520 to open pop up window 560, which requests the user to log-in by entering user ID 565a and password 565b, and then click submit button 565c. The rest of the process is the same as described above for Case I. MSP 60 then writes the encrypted user information into the user's Internet appliance.

Case III: The encrypted user information that MSP 60 wrote into the user's Internet appliance at the time the user logged in with MSP 60 has a time limit which is set to expire after a pre-determined period, either starting from the time the user logged in at MSP 60 or at the user's choice, to start from the last time a transaction took place at vendor web site 520. When the time expires, the systems and methods of the present invention will request the user to login again. The process then proceeds as for Case II above. This feature reduces the risk that a third party may use the user's Internet appliance to purchase content without the user's permission.

In another embodiment of the present invention, MSP 60 may download an “instant message” client software into the user's Internet appliance. This software displays a button 535 in a browser. When the user clicks button 535, the system will instantly display the summary of the user's content purchases during his/her log-in period or, alternatively, the last several transactions. This summary includes the vendor's URL address, content title, cost, date, and time, as well as the user's remaining balance of available tokens in the user's micropayment account with MSP 60. If a user wants to review all of his/her previous purchase activities, the user may log-in with MSP 60 and click a “my account” or “statements” button (field 267, FIG. 9). The system will display at the user's Internet appliance the user's micropayment account report which includes all business transactions that have taken place, vendor name, product name or content title, cost, date and time and type of transactions, which includes the user's purchase, add funds, disputed transactions and customer credit. It also will display the user's remaining balance of available tokens. The user may filter the account report with start date and/or with ending date or specific vendor(s) or specific type of transaction.

It should be understood by one skilled in the art that the processes describe above for a user to purchase content items on a vendor web site also may be used to purchase tangible goods or services on other vendor web sites. Advantageously, the systems and methods of the present invention enable users to purchase content items, tangible goods, or services on multiple vendor web sites without having to disclose any personal or billing information to the vendor web sites.

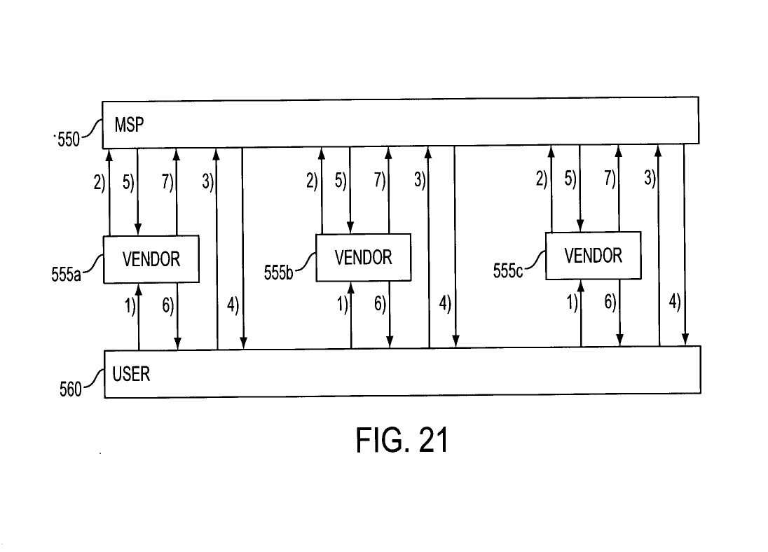

Referring now to FIG. 21, a schematic diagram showing steps taken by a user when purchasing content items using tokens at multiple vendor web sites is described. FIG. 21 illustrates how a user may browse multiple vendor web sites who accept tokens as payment and purchase content items freely and seamlessly without having to log-in or log-out at each and every vendor web site. Note that user 560 may purchase content from multiple vendors 555a-c in any sequence. User 560 may also visit any particular vendor 555a-c more than once. The systems and methods of the present invention, therefore, provide users the convenience of purchasing content items with micropayments at multiple vendor web sites without burdensome log-in and check-out processes at each vendor site.

In step 1), user 560 selects a content item for purchase at any of vendors 555a-c web sites using an Internet appliance, as he/she browses at various vendors 555a-c web sites. When user 560 clicks a content item displayed in one of vendors 555a-c web sites, the vendor web server sends the price of the content item user 560 clicked, together with the vendor ID to MSP 550, as shown in step 2). At the same time, user 560 Internet appliance sends the user ID to MSP 550, as shown in step 3). In step 4), MSP 550 subtracts the price of the content item from the user's micropayment account and authorizes the vendor web server for the user's purchase, as shown in step 5). In step 6), the vendor web server downloads the content item to the user's Internet appliance. In step 7), MSP 550 records the amount of royalty that the vendor needs to pay MSP 550 for the electronic micropayment transaction that took place. Note that the above steps 2), 3), 4), 5) and 7) are transparent to the user. This completes the purchase of a content item from a vendor web site. User 560 may continue to purchase other content items from the same vendor or browse to look for other content items to purchase at other vendor web sites seamlessly.

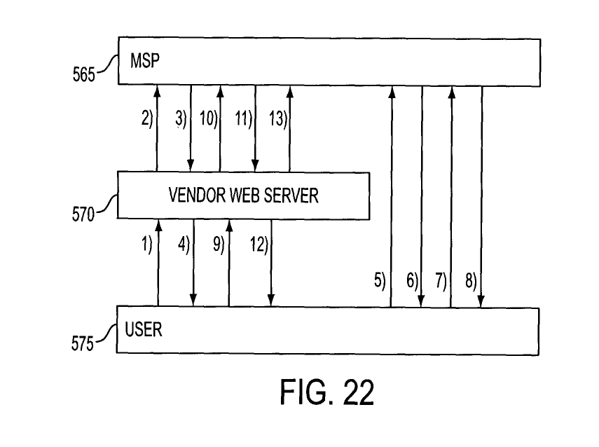

Referring now to FIG. 22, a schematic diagram showing system processes that take place when a user purchases content items using tokens at a vendor web site is described. In step 1), user 575 clicks at a content hyperlink to purchase a content item at a vendor web site hosted at vendor web server 570. In step 2), vendor web server 570 sends transaction data, including but not limited to vendor ID, content ID, content URL address, content title, an optional brief description of content, price, incentive token code (if applicable), time period for which the content item will be valid, and other parameters to MSP 565. In step 3), MSP 565 validates vendor and content top-level URL address to see if the content vendor is a member vendor that has registered with MSP 565 to offer electronic tokens as a payment method to users. If so, the process continues.

To preserve the integrity of the transaction data, the systems and methods of the present invention reduce the limit the frequency of the transmission of the transaction data through a communication line to prevent unlawful alteration of the transaction data, such as changing the price of content by an Internet intruder. To achieve this objective, upon receiving the transaction data from vendor web server 570, the present systems and methods cause MSP 565 to create a transaction ID for the transaction data and stores the transaction data in transaction database 130 (FIG. 4). MSP 565 then returns a function and transaction ID to vendor web server 570, as shown in step 3). Thereafter, communications between MSP 565 and vendor web server 570 or communications between vendor web server 570 and user 575's Internet appliance will use the transaction ID rather than transaction data.

In step 4), vendor web server 570 sends a function and transaction ID to user 575 Internet appliance. This function opens a new blank window on user 575 Internet appliance and causes user 575 Internet appliance to send the transaction ID and encrypted user ID to MSP 565, as shown in step 5). In step 6), MSP 565 displays the transaction data on user 575 Internet appliance including but not limited to content title, the optional brief description, and price with “Incentive”, “Buy”, and “Cancel” buttons. Note that it is necessary for MSP 565 to send transaction data including the price of the content item and display it at user 575's Internet appliance. However, MSP 565 will be using the actual transaction data, including but not limited to the price of the content item stored in its database (step 2) above) for validation of the transaction data before approving the micropayment transaction; therefore, it is difficult for a person to alter, for example, the price of the content item or other transaction data illegally.

In step 7), user 575 may click the “Buy” button to purchase the content item. If user 575 has incentive tokens in his/her micropayment account with MSP 565, user 575 may click the “Incentive” button to pay for the content item using incentive tokens. User 575 may decide not to purchase the content item after reading the brief description (optional) or simply decides not to go through with the purchase, in which case user 575 may click on the “Cancel” button. If user 575 clicks on the “Buy” button, the user 575 Internet appliance will send the incentive code (if applicable) and other transaction data back to MSP 565.

In step 8), MSP 565 validates the incentive code (if applicable) and other transaction data then checks to see if user 575 has logged in. If so, MSP 565 also checks if user 575 is still below his/her spending limit threshold. This is another security measure to protect the user's micropayment account with MSP 565. MSP 565 then checks whether user 575 has enough tokens or incentive tokens (if applicable) to make the purchase. If the above validations and checking for user 575's available tokens are successful, MSP 565 encrypts the user ID with a time-variant encryption key, opens a blank window on user 575's Internet appliance at the content URL address and submits the encrypted user ID and content ID to user 575 Internet appliance. In step 9), user 575 Internet appliance in turn submits the encrypted user ID and content ID to vendor web server 570. Further, vendor web server will send the encrypted user ID and content ID to MSP 565, as shown in step 10).

In step 11), MSP 565 decrypts the user ID and checks if user 575 has “access” to the content URL address. A user having “access” to the content URL address means that the user has logged in with MSP 565 and that the user's time-variant encrypted user ID is valid, the user paid for the content item, and all the other transaction data are valid. If yes, MSP 565 sends authorization to vendor web server 570. In step 12), vendor web server 570 displays and downloads the content item to user 575 Internet appliance. In step 13), MSP 565 records the amount of royalty that the vendor needs to pay MSP 565 for the electronic micropayment transaction that took place. Note that the above steps 2), 3), 4), 5), 8), 9), 10), 11) and 13) are transparent to user 575. This completes the micropayment transaction of a user purchasing content from a content vendor web site.

The processes described in FIG. 22 above provide security means for unauthorized downloading of content items from a content vendor web site and prevent unauthorized alteration of the transaction data by an Internet intruder. The royalty rate that the operator of MSP 565 charges to the vendor allowing user 575 to purchase content items using tokens may vary from one vendor to another vendor depending on the amount of the content items sold by a vendor within a pre-determined period of time.

In yet another embodiment of the present invention, the system maintains transaction records in its transaction database 130 (FIG. 4). The settlement of paying vendors for tangible goods, content, or services sold or rented to users occurs when it is triggered by one of two events:

First: The amount to be paid to a vendor reaches a pre-determined threshold value. This threshold value is pre-agreed upon between each vendor and the operator of MSP 565. This value may be different for each vendor.

Second: The date for settlement is pre-agreed between each vendor and the operator of MSP 565. This date may be once per week, twice per month, once per month or other arrangement as previously agreed and they may be different from one vendor to the other. The payment settlement based on a pre-agreed date may not take place if the pre-determined amount threshold is not reached.

The settlement of payment as described above eliminates the settlement for each and every business transaction between MSP 565 and a vendor whenever an electronic micropayment transaction takes place between a user and a vendor. Therefore, it reduces the costs and fees of account settlement that is charged by the bank(s) each and every time the payment from MSP 565 to the vendor takes place.

Referring now to FIG. 23, a flow chart for purchasing tokens or adding funds to a micropayment account is described. The user may purchase tokens either online or offline as shown in step 585. The user may indicate in which currency he/she wants to purchase tokens. Unless specifically indicated, the tokens to be purchased will be in U.S. dollars or the currency of the country where the vendor is located. If the user wants to purchase tokens offline, the user is requested to make payment to the MSP's specified bank account as shown in step 600. Upon confirming receipt of the deposit from the user, step 605, the MSP system administrator will enter the amount of funds received into the user's micropayment account in user record 195 (FIG. 6), updating the user's balance to reflect the new tokens purchased, as shown in step 620.

If the user wants to purchase tokens online and the purchase is being made through a vendor, the systems and methods of the present invention will set the vendor association flag to the vendor ID, step 595, which will be recorded, as described later with respect to step 635. In step 610, the system then inquires of the user regarding the amount of tokens or funds the user wishes to purchase or add to his/her micropayment account with the MSP. Upon receiving the amount desired, the system debits the user's credit card or user's bank account or whichever payment method the user provided, as shown in step 615. The MSP will then update user record 195 (FIG. 6), to reflect the new tokens purchased as shown in step 620. Step 625 indicates that user record 195 in user database 120 (FIG. 6) is updated to reflect the amount of tokens purchased. This transaction is also entered in the user's micropayment account activity record. Transaction database 130 and aggregated total token sold record 210 both in FIG. 6 are also updated.

If the purchase of tokens is made through a vendor, step 630, the sales record in vendor record 200 (FIG. 6) will record the user ID and the amount of the user token purchase. The account status in user record 195 (FIG. 6) then will be updated to reflect the purchase of tokens from a specific vendor, as shown in step 635. This information may be used by the operator of the MSP to reward the vendor for attracting users to purchase tokens. Similarly, the information may be used by a vendor to reward users for purchasing tokens by issuing incentive tokens to the users, for example. The operator of the MSP may also provide certain incentives to encourage each and every vendor to attract users to purchase more tokens.

The incentive tokens issued by a vendor to such users can be used to purchase tangible goods, content, or services from the issuing vendor only. The incentive tokens may or may not have an expiration date. These initiatives to issue incentive tokens are strictly at the vendor's own discretion without any restriction from a third party such as a bank or the operator of the MSP. User database 120 and vendor database 125 (FIG. 6) store the detail of various incentive tokens issued to a user by a vendor.

Lastly, at step 640, the system sends an email to the user at the end of each day, confirming that a business transaction took place. The user may log-in with the MSP and review his/her account activities which will show that the user purchased a certain amount of tokens through a vendor or directly through the MSP, as well as the amount, date and time of purchase.

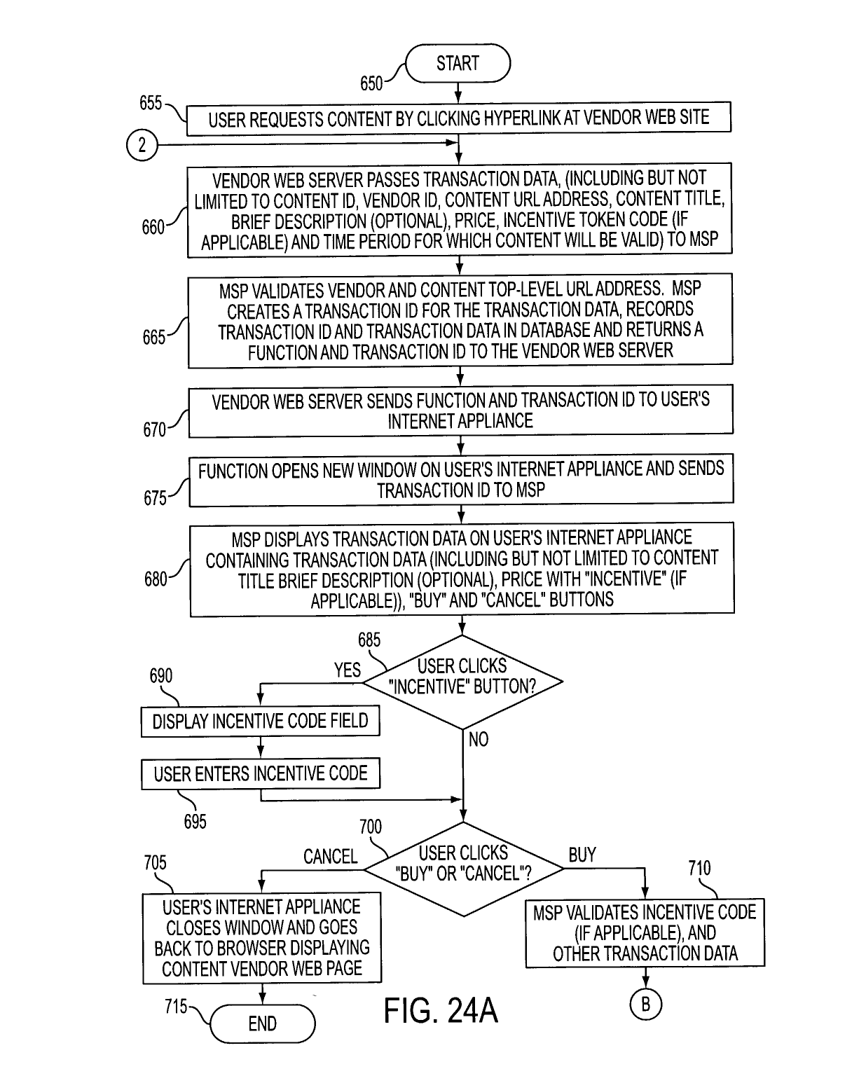

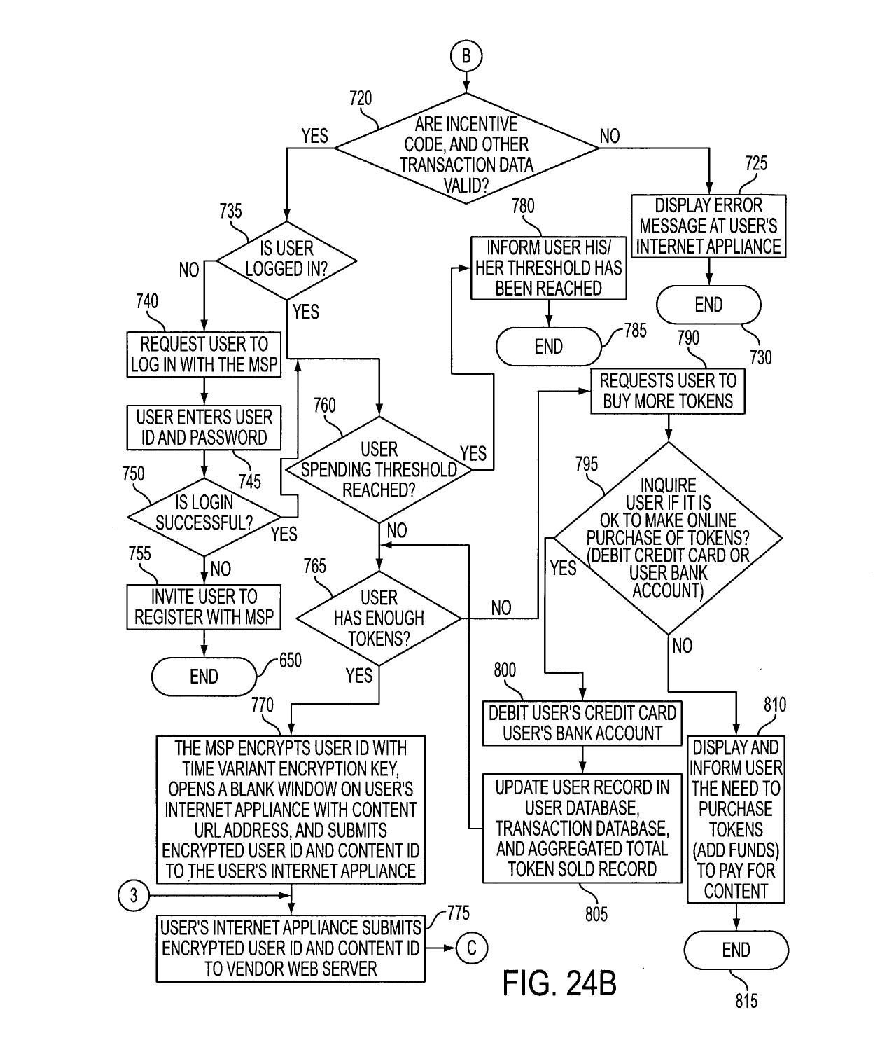

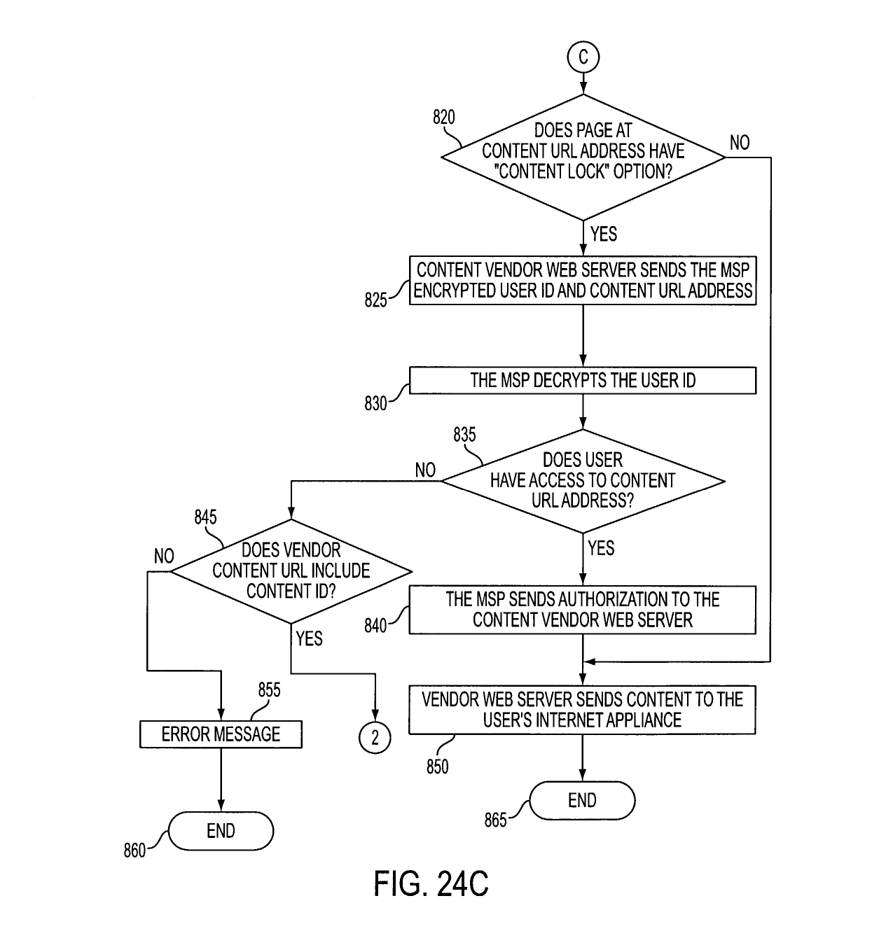

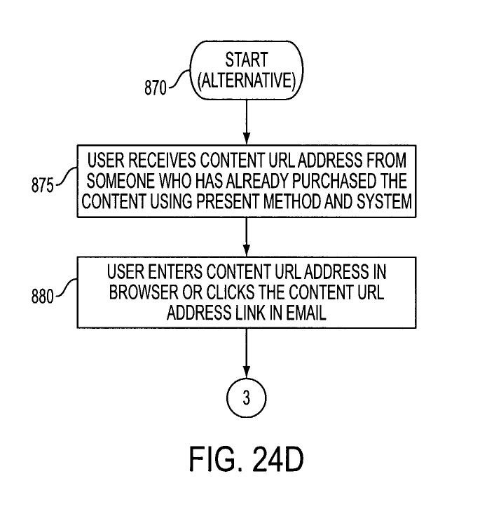

Referring now to FIGS. 24A, 24B, 24C, and 24D, flow charts for purchasing content securely to validate the vendor and content URL address, to preserve the integrity of the transaction data and authentication of the user, and to prevent unauthorized viewing or downloading of content are described. A user browses to a content vendor web site, step 655, and clicks at a content hyperlink to purchase the content item. This causes the vendor web server to pass transaction data, including but not limited to vendor ID, content ID, content URL address, content title, optional brief description of content, price, incentive token code (if applicable) and time period for which the content item will be valid, to the MSP, as shown in step 660.

In step 665, the MSP validates the vendor and content top-level URL address to see if the content vendor is a member vendor registered with the MSP to offer electronic tokens to users as a payment method. The MSP then creates a transaction ID for the transaction data and records the transaction ID and transaction data in transaction database 130 (FIG. 6). The transaction ID refers to the transaction data the MSP received. The MSP then returns a function and transaction ID to the vendor web server. In step 670, the vendor web server sends the function and transaction ID to the user's Internet appliance. The function then opens a new window on the user's Internet appliance and sends the transaction ID to the MSP, as shown in step 675.

In step 680, the MSP displays a window on the user's Internet appliance containing transaction data including but not limited to content title, optional brief description of content, and price of the content item with “Incentive” (if applicable), “Buy” and “Cancel” buttons. If the content item is purchasable using an incentive token either issued by the content vendor or by the operator of the MSP, the user may click on the “Incentive” button to pay for the content item using incentive tokens that the user has in his/her micropayment account with the MSP, as shown in step 685. In step 690, the system displays a field in the same window requesting the user to enter the incentive code that has been assigned to the user. After the user enters the incentive code, step 695, the user may click on the “Buy” button, as shown in step 700.

If the content item is not purchasable using an incentive token, the systems and methods of the present invention will not display the “Incentive” button at the display window in the user's Internet appliance. In this case, the user may click on the “Buy” or “Cancel” buttons as shown in step 700. If the user clicks on the “Cancel” button, the displayed window will be closed and the user's Internet appliance will go back to display the content vendor web pages as shown in step 705.

If the user clicks on the “Buy” button, the MSP will validate, in step 710, the incentive code (if applicable) and other transaction data. If any one of these transaction data is incorrect, step 720, the MSP will display an error message at the user's Internet appliance, step 725, and the user can close this error message window and go back to the content vendor web site. If the validation of all of the above transaction data by the MSP is successful, the MSP checks to see if the user has logged-in, as shown in step 735.

Note that the systems and methods of the present invention enable a user to log-in with the MSP only once and to browse several content provider vendor web sites to purchase content items from different vendor web sites without requiring the user to log-in or check-out at each and every vendor web site. However, in order to prevent unauthorized use of the user's Internet appliance to purchase content, the user will be required to log in with the MSP again after a pre-determined time period is reached either from the time the user logged in or from the time the user made the last content purchase, whichever the user has chosen.

If the user has not logged in or the time since the user logged in has expired, the MSP will request the user to log-in with the MSP, as shown in step 740. After the user enters the user ID and password, step 745, the MSP checks to see if the user has successfully logged in with the MSP, as shown in step 750. If not, the MSP will invite the user to register with the MSP, step 755, and close the window allowing the user's Internet appliance to return to display the content vendor web pages.

Since the user only needs to login with the MSP, and that entering of user ID and password take place between the user's Internet appliance and the MSP server, the vendor web server is not aware of the user's identity. This allows the system to preserve the user's privacy and maintains anonymity of the user from the vendor.

If the user has previously logged in or the user logged in successfully as shown in step 750, the MSP will proceed to check if the user is still within the spending limit threshold, step 760. If not, the MSP informs the user that his/her spending limit threshold has been reached and terminates the user's purchasing of content. This is another security measure provided by the present systems and methods as invented to protect the user from unauthorized use of the user's micropayment account with the MSP.

If the user is within the spending limit threshold, the MSP will proceed to check if the user has enough tokens in his/her personal account to pay for the content item, as shown in step 765. If yes, the MSP encrypts the user ID with a time-variant encryption key and opens a blank window on the user's Internet appliance with the content URL address and submits the encrypted user ID and content ID to the user's Internet appliance, as shown in step 770. In step 775, the user's Internet appliance then submits the encrypted user ID and content ID to the vendor web server. Note that only the encrypted user ID with the time-variant encryption key for the user and no other user information is sent to the vendor web server. This preserves the anonymity of the user from the vendor.

The present systems and methods permit the content vendor an option to “Lock content” to prevent unauthorized downloading of content by a third person. This unauthorized downloading of content is possible, if the user copies the content URL address and encrypted user ID and sends it to a third person such as a member of the user's family or a user's friend. The user ID is encrypted with a time variant encryption key so that the user ID becomes invalid when the time expires. Therefore, the systems and methods of the present invention reduce the risk of unauthorized viewing or downloading of content from the content vendor web page.

In step 820, the vendor web server checks to see if the content URL address has the “Lock Content” option. If yes, the vendor web server sends to the MSP the encrypted user ID and the content URL address, as shown in step 825. The MSP decrypts the user ID, step 830, and checks to see if he/she has “access” to the content URL address, as shown in step 835. The user has “access” to the content item if the user ID is valid (i.e., the time-variant encrypted user ID has not changed), paid for the content item, the time period for which the content is valid has not expired, and the number of times to access the content item is not exceeded.

In step 845, if the user has no “access” to the content, the MSP will check if the content URL includes the content ID. If yes, the process goes to step 660 (FIG. 24A), as described earlier. If no, the MSP displays an error message and terminates the process, as shown in step 855. In step 840, if the user has “access” to the content, the MSP sends authorization to the vendor web server and in step 850, the vendor web server sends or downloads the content to the user's Internet appliance.

Referring again to step 820, if the content URL address does not have the “Lock Content” option, the vendor web server will display or download the content item to the user's Internet appliance as previously described in step 850.

Referring again now to step 765 (FIG. 24B), if the user does not have enough tokens to make the purchase of the content item, the MSP will request the user to purchase additional tokens (or add funds) to the user's micropayment account, as shown in step 790. The MSP will further inquire if it will be acceptable to the user to use the user's credit card or personal bank account the user has previously provided to the MSP at the time of the user's registration to make an online purchase of tokens as shown in step 795.

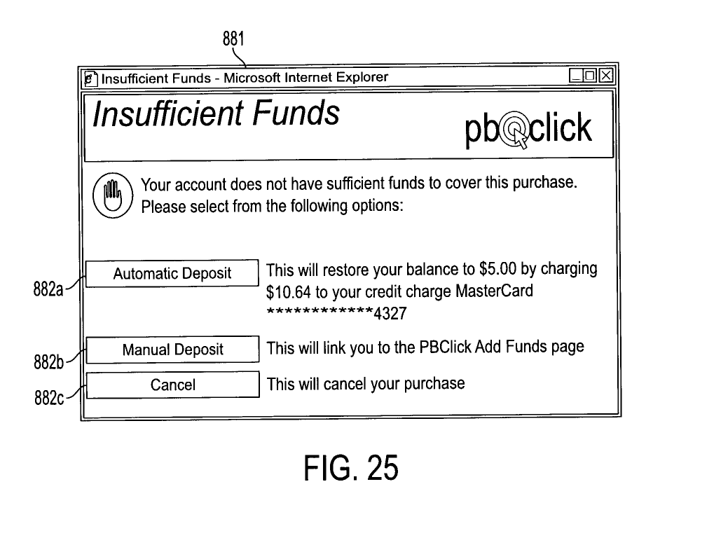

To provide the user convenience and ease of use, the system will display a window to the user indicating that the user does not have enough tokens to cover the purchase with the remaining user's balance and inquiring the user if he/she wants to purchase additional tokens. An illustrative window is shown in FIG. 25. Window 881 provides the user with choices 882a-c to proceed:

Choice 882a: Automatic deposit for instant purchase of additional tokens. To facilitate the purchase, the system will debit the user's account with a “top off” amount plus a shortage amount for the current purchase. The “top off” amount is typically set at a level that will cover the cost of debiting the user's account such as the cost for charging the user's credit card;

Choice 882b: Manual deposit that will take the user to user interface 85 (FIG. 3) for the user to add funds to his/her micropayment account; and

Choice 882c: The user may cancel the purchase of content.

Referring back to FIG. 24B, if the user agrees, in step 800, the MSP charges the user's credit card or debits the user's personal bank account for the amount of the new tokens the user purchased. These new tokens the user purchased are in the currency indicated in the price of the content item.

In step 805, the MSP updates the user's account balance to reflect the new tokens purchased, in user record 195 in user database 120, transaction database 130 and aggregated total tokens sold record 210 in database server 110, FIG. 6. The above records are updated for the currency the user used to purchase new tokens. The MSP will then proceed to step 765 as described earlier. If the user does not wish to purchase additional tokens online, the MSP will display and inform the user that he/she needs to purchase more tokens (add funds) to his/her account in order to purchase the content item, as shown in step 810.

FIG. 24D describes an alternative method by which a third person may purchase the content item that a user previously purchased. In step 875, a third person (a new user) receives the content URL address from someone who has already purchased the content item using the present system and methods. A new user may enter the content URL address in the browser or click on the content URL address in the email the new user received, as shown in step 880. The user's Internet appliance submits the encrypted user ID and content ID to the vendor web server as described in step 775 (FIG. 24B). The process will then take place as described earlier. If a new user is already registered at the MSP, he/she can then proceed to purchase the content item, however, the new user will be required to pay for the content item using tokens in his/her account because the encrypted user ID the new user received has a time variant encryption key and it will have expired.

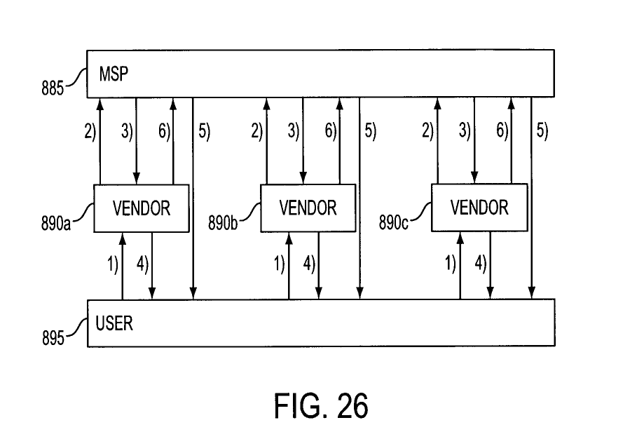

Referring now to FIG. 26, a schematic diagram showing steps taken by a user when purchasing tangible goods or services using tokens at a vendor's web site though a check-out process is described. In step 1), user 895 requests to purchase products or services through a check-out process at one of vendors 890a-c web site and selects tokens as his/her payment method. In step 2), the web server of one of vendors 890a-c sends the vendor ID, user ID and password and the total amount of tokens required for purchase of tangible goods or services to MSP 885. MSP 885 accesses user record 195 in user database 120 (FIG. 6) and checks to see if user 895 has enough tokens to make the purchase. If so, then MSP 885 subtracts the required tokens from the user's account balance and authorizes the vendor for the micropayment transaction as shown in step 3).

If user 895 is given prior permission for payment at a later time, MSP 885 may debit the account of user 895 for the required tokens for future payment and authorize the vendor for the micropayment transaction. In this case, the required tokens are also subtracted from the user account's balance. The present system thereby permits a vendor or the operator of MSP 885 to provide a credit line to a user. In such case, the user account balance may show a negative number. The extent of this “negative draw” that a user is allowed to have depends on the credit line limit that a vendor or the operator of MSP 885 provides to the user.

Upon receiving authorization from MSP 885, the vendor confirms the micropayment transaction and delivers tangible goods or services to user 895 as shown in step 4). In step 5), MSP 885 sends an email to user 895 confirming that the micropayment transaction took place. In case user 895 finds that he/she did not make the micropayment transaction, user 895 can immediately notify MSP 885 to disable his/her account until further investigation. In step 6), MSP 885 records the amount of royalty that the vendor needs to pay MSP 885 for the electronic micropayment transaction that took place. Note that the above steps 2), 3) and 6) are transparent to the user. This completes the business transaction.

The present methods and systems permit the royalty rate that the operator of MSP 885 charges to a vendor for electronic micropayment transactions using tokens as payment to vary from one vendor to another vendor, depending on the total amount of the transactions that takes place in a pre-determined period of time such as monthly, quarterly and so forth. This royalty rate for a vendor can also be set to decrease in a sliding scale depending on the total amount of sales in order to reward the vendor for its sales and marketing efforts.

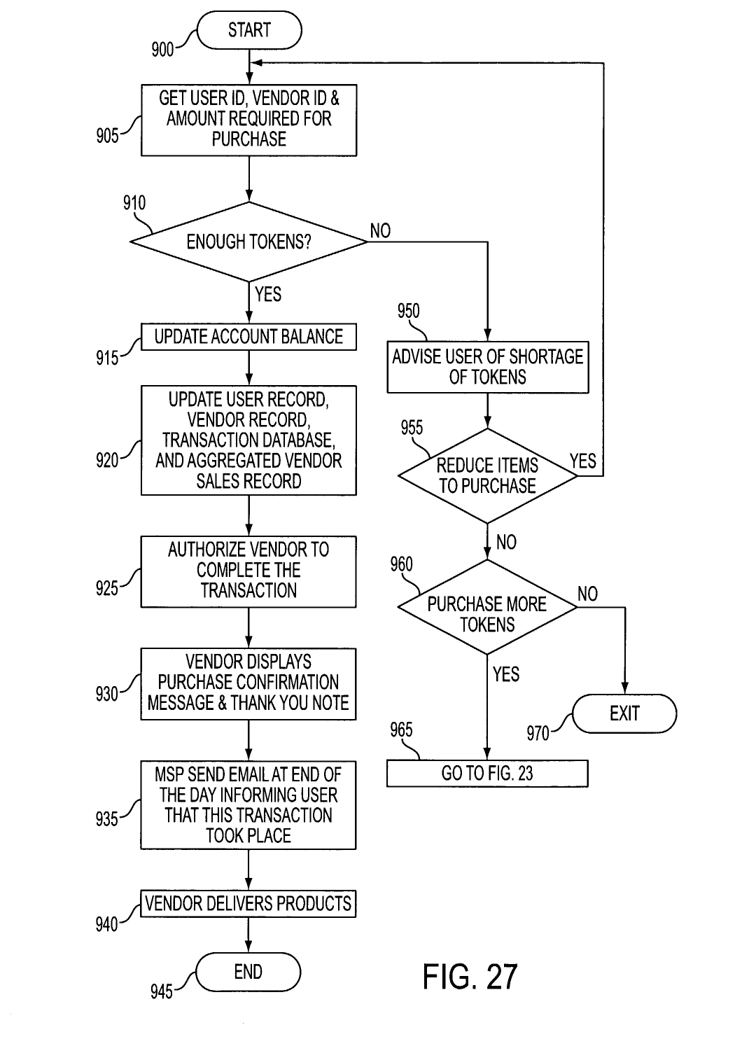

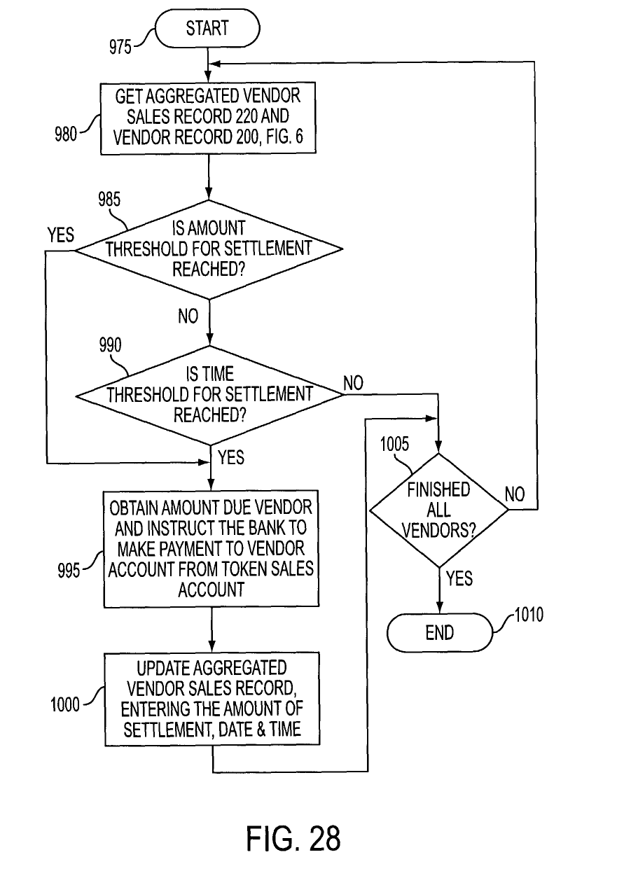

Referring now to FIG. 27, a flow chart for purchasing tangible goods at a vendor's web site is described. The user first logs in with the vendor by entering the user ID and password. The user then selects tangible goods from the vendor web site and adds the tangible goods into a shopping cart. This process is the same with most online shopping vendor web pages currently available on the Internet.

When the user wishes to check-out the goods, most of the vendor web pages will inquire of the user as to how he/she wishes to pay for the goods by allowing the user to select one of the various credit card options accepted by the vendor. If the vendor accepts tokens as a payment option, the vendor web page will also display tokens, in addition to the various credit cards. If the user selects tokens as the payment method, it causes the MSP to drop a window requesting the user to enter the user ID and password that the user registered at the MSP. When the user clicks a “submit” button, the vendor web server sends the user ID, password, vendor ID and the amount of tokens that is required for the user to make the purchase to the MSP, as shown in step 905.

Upon receiving the above information, the MSP will access user record 195 (FIG. 6) to see if the user has enough tokens in his/her account to make the purchase, step 910. If yes, the MSP will update the user's account balance as shown in step 915. In step 920, the MSP updates user record 195, vendor record 200, enters a transaction record in transaction database 130 and an aggregated vendor sales record 220 in MSP database server 215 (FIG. 6). The MSP then authorizes the micropayment transaction for the vendor in step 925. As with most online shopping web sites, the vendor web site displays the purchase confirmation and sends a thank you note in step 930. In step 935, the MSP sends an email at the end of the day or immediately upon completion of the micropayment transaction, to the user informing the user that he/she had at least one business transaction during the day.

The user may log in with the MSP to review the detail of the micropayment transaction(s) at user interface 85 (FIG. 3). This adds another level of security allowing the user to disable the user's account with the MSP if the user finds any irregularity in the transaction record. The vendor may deliver tangible goods to the user as shown in step 940 and complete the business transaction.

In this case, shipping information for the goods may be submitted to the vendor by the user or by the MSP, depending on privacy agreements the user enters with the MSP at the time of opening his/her user account. If the user elects not to disclose any shipping information to the vendor, the vendor may have to ship the goods to the MSP so that the MSP can then ship the goods to the user. It should be understood by one skilled in the art that other ways to disclose shipping information to the vendor may be provided without necessarily having to disclose user's personal information to the vendor.

If the user does not have enough tokens to make the purchase, the MSP will inform the user of the shortage of tokens in the user's account at step 950. The user will have an option to reduce the amount of products he/she is purchasing, step 955, or purchase additional tokens, step 960. In step 965, if the user chooses to purchase additional tokens, the user will be prompted to do so as described in FIG. 23.

While current online shopping at vendor web sites that allows a user to select one or more products and place them into a “shopping cart” and to perform a check-out process to settle payment for tangible goods being purchased works reasonably well, this method of business transaction is not suitable for a user to purchase content on the Internet for the following reasons:

First: when a user selects a content item (e.g., article, publication, music, software, movie) for purchase, he/she prefers to have the content item downloaded into his/her Internet appliance and have the convenience to be able to browse other vendor web sites for other content without having to perform a “log-in” and a “check out” process at each and every vendor's web site.

Second: a user may want to re-visit a published article which he/she paid and read at his/her Internet appliance display screen after he/she browses several other vendor web sites, without having to pay for the same content again.

Third: the cost for each content item is usually so small, on the order of few cents or dollars, that the cost for payment of content using a credit card does not justify such purchases.

Fourth: the process of using a shopping cart for purchases that total only pennies, a few dollars or even the equivalent of fractions of a penny is not practical.

The other embodiments of the systems and methods described hereinabove with reference to FIGS. 20-22 provide users the convenience for purchasing content at multiple content vendor web sites without requiring log-in and check-out at each and every web site.

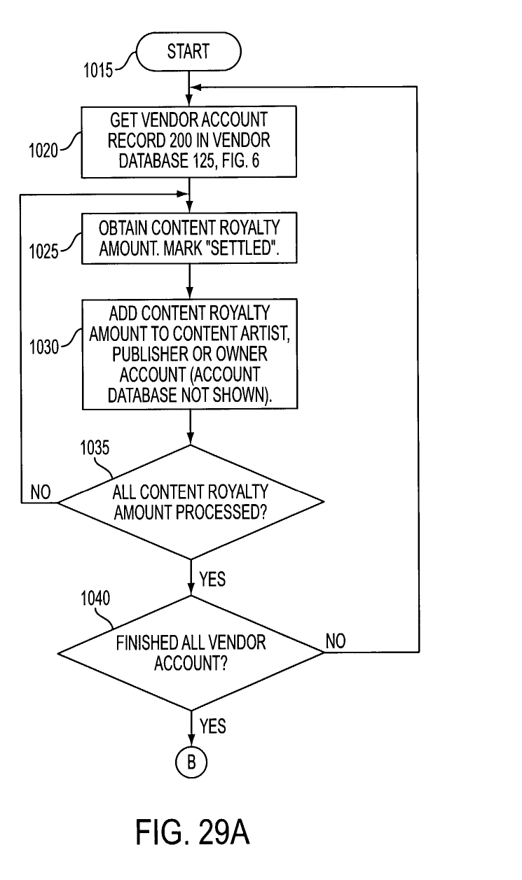

Referring now to FIG. 28, a flow chart is described for aggregating the settlement of payments to vendors by the MSP when settlement thresholds, either by amount or by time, are reached by each vendor. In step 980, the systems and methods of the present invention retrieve aggregated vendor sales record 220 and vendor record 200 (FIG. 6) and check to see if the amount threshold has been reached for the vendor as shown in step 985. If not, the system continues to check if the time threshold has been reached, step 990.

Note that both the amount threshold and the time threshold may be different from one vendor to the next vendor. These thresholds are pre-determined between each vendor and the operator of the MSP and they are recorded in vendor record 200. If the result of checking either the amount threshold (step 985) or time threshold (step 990) is positive, the system will obtain the amount due the vendor from aggregated vendor sales record 220 (FIG. 6) and instruct the bank to make payment from the token sales account 225 to the vendor account 230a for the amount due the vendor, as shown in step 995. This settlement of payment by the operator of the MSP with a vendor may be done using an offline method such as sending a check to the vendor (not shown).

In step 1000, the MSP updates aggregated vendor sales record 220 (FIG. 6) by entering the amount of the settlement (payment), date, and time. If the vendor's amount threshold or the time threshold has not been reached, no account settlement is processed for the vendor. The above account settlement process is performed for each and every vendor that registered with the MSP to use tokens as one of the user's payment option. In step 1005, the system checks to see if all vendor settlements have been processed. If no, it gets the next aggregated vendor sales record 220 and vendor record 200 (FIG. 6), as shown in step 980. If yes, the process is complete and re-started at the pre-determined time or time interval.

The systems and methods of the present invention permit users to dispute any transaction they have conducted. Typical reasons for a dispute would be a problem downloading or accessing purchased material or an inadequate description or representation of the content such that the user purchased it and realized that it did not contain what he/she wanted. If a user disputes a sufficiently large number or amount of transactions, a dispute can become “pending” until an administrator has time to review that dispute. However, to save on service costs, the MSP has defined a number of conditions that will allow the system to automatically process disputes and make a refund of sufficiently small value or quantity that it would not be allowed to dispute a transaction past a given number of days. The number of days will be pre-determined by the MSP operator and may be set differently for each currency. And, if small amounts are disputed, the systems and methods of the present invention will automatically authorize the dispute and reverse the transaction. A dispute will qualify for automatic authorization if the following conditions, which are pre-determined by the MSP operator, are met:

Condition I: The total amount disputed by the user during a time period (pre-determined by the MSP for each currency) is less than “m” in each currency, with “m” being a currency amount set by the MSP for each currency.

If Condition I is not met, a dispute will still qualify for automatic authorization if the following conditions are met:

Condition II: The total amount disputed by the user during a time period (pre-determined by the MSP for each currency) is less than a percentage of the total amount of purchases (pre-determined by the MSP for each currency) made by the user during that period of time.

Condition III: The total number of disputed purchases by the user during a time period (pre-determined by the MSP for each currency) is less than a percentage of the total number of purchases (pre-determined by the MSP for each currency) made by the user during that period of time.

Condition IV: The total number of disputed purchases by the user during a time period (pre-determined by the MSP for each currency) is less than “n” (“n” being a number pre-determined by the MSP for each currency).

The systems and methods of the present invention also provide a back-end interface that includes a security feature for system administrators by which each function of that back-end interface is associated with a security level or function. The system administrator logins can be given a security profile that enables only the specific subset of the possible security functions that they require to perform specific tasks. Under such a system administrator login, disabling a security function will cause the controls for that function to be hidden. Both vendor and MSP administrator back-end interfaces may include this security feature.

To make things easier to manage, a system administrator with sufficient security rights can also create a security group with a subset of that same system administrator's security functions. This makes it easier for a security administrator to control the rights of a large number of people by adding or removing them from security groups.

The systems and methods of the present invention also protect the user's private information from leaking to any participating vendors. To provide the user convenience to obtain information on any participating vendors, the system permits the user to have an “opt-out” or an “opt-in” choice.

The opt-in choice gives users the opportunity to receive additional information from vendors about sales and promotions, while continuing to maintain the highest possible privacy standards. This will be achieved in several ways. If a user is referred to the MSP by a vendor, he/she will follow a link from the vendor's web site to the MSP's registration form. Upon completing the registration, the last page will include a paragraph worded approximately, “Yes, I want [vendor name] to send me information about special offers and promotions” and will be accompanied by a check box that, by default, will be checked. The user can opt-out of this choice by unchecking the box. If the user leaves the box checked, one of two possible things will happen: the MSP will send limited information (i.e., the user's email address) to the vendor; or the MSP will route the user back to the vendor's web page to fill out a separate form. Opting out on registration will prevent the following opt-in method from occurring.

The MSP will allow a user who is already registered with the MSP to choose the opt-in option for marketing from vendors when they shop with those vendors for the first time. The opt-in option involves linking the user to a web page at the vendor's web site where the user can sign themselves up onto the vendor's mailing list. The method of delivery of this link can be accomplished in one of two ways: when the user shops at the vendor for the first time, the MSP will display a message at a user's Internet appliance containing a link to the vendor's mailing list sign-up page; and when the user shops at a vendor for the first time, the MSP server sends out the nightly “transaction summary” email, the email including a short message about that vendor, and perhaps including the vendor's logo and a link to the vendor's mailing list sign-up page.

In another embodiment of the present invention, content authors, publishers or other intellectual property owners accrue royalties whenever users purchase content from each and every vendor web site that is authorized by MSP 60 to use tokens as a user's payment option for content. Since the price for each content will normally be very small, requiring micropayments such as that described in the methods and systems of the present invention, the compensation to be paid to such content authors, publishers or other intellectual property owners will be even smaller, perhaps, in the range of the equivalent of a fraction of a penny. This requires aggregation of micropayments. The content royalty amount is entered into vendor record 200 (FIG. 6) at the same time an electronic transaction is recorded in transaction database 130 (FIG. 6.) This content royalty amount is also added to the aggregated content royalty amount within aggregated vendor sales account 220 (FIG. 6) for each transaction between a user and a content vendor. At the time of settlement of payments between MSP 60 and each vendor, this aggregated content royalty amount is deducted so that the operator of MSP 60 may pay each respective content author, publisher or other intellectual property owner the royalty amount withheld from each content vendor, at a later date.

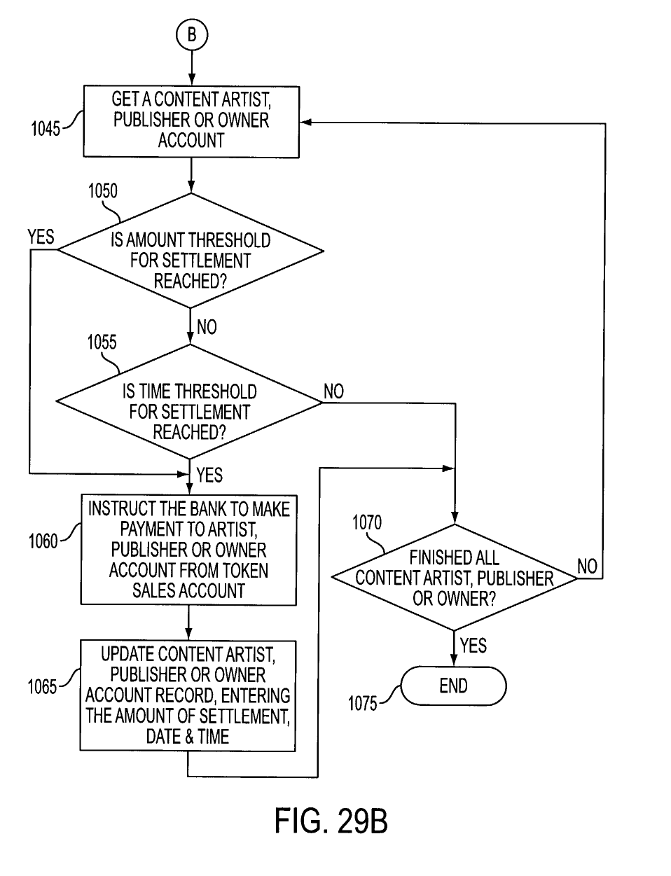

Referring now to FIG. 29A and FIG. 29B, a flow chart for computation of aggregated content royalty amount for each content author, publisher or other intellectual property owner and settlement of payments to them is described. At step 1020, the systems and methods of the present invention access a vendor record 200 (FIG. 6) and retrieve the content royalty amount and mark “settled”, at step 1025. At step 1030, the content royalty amount is added to the account set-up for each and every content author, publisher or other intellectual property owner. This process is repeated for all content royalty amounts recorded in vendor record 200, step 1035. At step 1040, the system checks to see if vendor record 200 for all vendors has been processed. If no, it obtains the next vendor record 200 (FIG. 6) as shown in step 1020. If yes, the system moves on to settlement of payments to all content authors, publishers or other intellectual property owners.

At step 1045, the systems and methods of the present invention retrieve the account of a content author, publisher or other intellectual property owner and then check to see if the amount threshold has been reached for the content author, publisher or other intellectual property owner, as shown in step 1050. If not, the system continues to check if the time threshold has been reached, step 1055. Note that both the amount threshold and the time threshold may be different from one content author, publisher or other intellectual property owner to the next.

These thresholds are pre-determined between each content author, publisher or other intellectual property owner and the operator of MSP 60 and they are recorded in the account set-up for each one of them. If the result of checking either the amount threshold (step 1050) or the time threshold (step 1055) is positive, the system will instruct the bank to make payment from token sales account 225 (FIG. 6) to the bank account (not shown) of the content author, publisher or other intellectual property owner, as shown in step 1060. This settlement of payment by the operator of MSP 60 described above may be done using an offline method such as sending a check to the content author, publisher or other intellectual property owner.

At step 1065, MSP 60 updates the content author, publisher or other intellectual property owner by entering the amount of the payment settlement, date and time. If the account threshold or the time threshold has not been reached, no account settlement is processed for the content author, publisher or other intellectual property owner. The account settlement process described above is performed for each and every content author, publisher or other intellectual property owner whose content is sold by each and every vendor registered with MSP 60 to use tokens as one of the user's payment options.

At step 1070, the system checks to see if all content authors, publishers or other intellectual property owners have been processed. If no, it obtains the next account for the next content author, publisher or other intellectual property owner, as shown in step 1045. If yes, the process is completed and re-started at the pre-determined time or time interval.

In another embodiment of the present invention, a user registered with MSP 60 is permitted to send tokens (electronic funds) available in his/her account 195 in user database 120 (FIG. 6) to another user who also is registered with MSP 60 and has his/her own account 195 in user database 120. This feature provides the capability for auctions being conducted in auction web sites to use tokens instead of credit card or using electronic payment services provided by various Internet payment service providers. The auction buyer requests MSP 60 to transfer tokens from his/her account 195 to the seller's user account 195. The advantage of using tokens instead of a credit card will become more evident if the item being put into auction is priced so low that the payment by the buyer to the seller using a credit card becomes cost prohibitive. Using tokens for auctions will open up opportunities for sellers to sell and buyers to buy content items, tangible goods, or services that can be priced at a much smaller price point than that provided by current auction sites.

Furthermore, the operator of MSP 60 may not charge a user to transfer his/her tokens to the auction seller's user account since micropayment server 80 can perform such task easily at no cost. This adds another advantage for auction sites since current auction buyers need to pay service charges to electronic payment service providers. If the auction seller wishes to obtain real currency instead of tokens, the seller may request MSP 60 to remit tokens for cash. The operator of MSP 60 may then charge the seller (or user) some service charge for redeeming tokens into real currency. Upon receiving a request from the user, the operator of MSP 60 will remit funds to the user by sending the check or depositing the funds into the user's bank account.

The transfer of tokens for one user to another as described above, may not be limited to an auction. The methods and systems as invented may be used by a person to send money to the other as an electronic person-to-person (P2P) system. The receiver initially receives the funds in the form of tokens. Unlike current electronic P2P systems, he/she may have the flexibility of “cashing-in” all or a portion of the tokens received.

In yet another embodiment of the present invention, micropayment server 80 (FIG. 3) permits several users to use a single user account. For example, in some cases, it is desirable that several members of a family may purchase tangible goods, content or services from vendor web sites who are authorized by the operator of MSP 60 to accept tokens as one of the user's payment options. Similarly, a company may establish a corporate account with MSP 60 allowing several of its authorized employees to make corporate purchases at various web sites using the same corporate account. In the case of purchasing a company's own tangible goods within the same corporate account, a company may wish to have its employees purchase that company's own products by its authorized employees who need to re-stock that company's inventory in its retail stores located in various territories. In this case, the methods and systems of the present invention could be used to track each and every purchase made by the authorized employees through the company's account established with MSP 60. This not only ensures accurate accounting for internal purchases of the company's own tangible products but also reduces the overhead costs to issue purchase orders and to make payments for invoices for each and every purchase made by employees.

To transact the various purchase scenarios described above, the methods and systems of the present invention allow user account 195 in database 120 (FIG. 6) to have multiple passwords (not shown). Each of the multiple passwords to a user account corresponds to a member of a family or an employee of a corporation, as described in the examples above. Micropayment account user interface 85 will have a user interface screen that will allow a user to enter additional passwords in a user account 190 in database 120 (not shown). The account summary screen will identify each member of the multiple member account corresponding to each of his/her respective transaction displayed (not shown).

In addition, the user statement screen will allow filtering of an account statement by a member of a multiple member account, in addition to filtering the statement by start/end date, type of transaction, amount of transaction, and so forth (not shown). Furthermore, although not shown, micropayment account user interface 85 will have a user interface screen that will allow a user to set various access and spending limits for each and every member of the multiple member account. The spending limit may be set to prevent, for example, a member of the family from spending in excess of the agreed upon account balance or in the case of children, from accessing undesirable web sites.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for conducting electronic commerce transactions between a user and a plurality of vendors offering tangible goods, content, or services for rental or sale at a plurality of vendor web sites, the method comprising:
issuing a plurality of electronic tokens from a micropayment service provider server of a micropayment service provider to a user suitable for use in micropayment transactions;
providing a micropayment user account to the user, each micropayment user account in the plurality of micropayment accounts storing a subset of the electronic tokens purchased with a different currency;
providing a micropayment vendor account to each one of the plurality of vendors for settling payments for electronic tokens used by the user;
facilitating the purchase of tangible goods, content, or services from one or more of the plurality of vendors without the user having to disclose personal information to one or more of the plurality of vendors; and
for each electronic transaction between the user and a vendor, recording a royalty transaction in a corresponding micropayment vendor account.

2. The method of claim 1, wherein a subset of the vendors offer content that is hosted at the vendor web sites, the method further comprising:
providing content to the user in exchange for electronic tokens; and
for each electronic transaction, recording a royalty transaction for the content in a corresponding micropayment vendor account.

3. The method of claim 1, further comprising maintaining a user database in the micropayment service provider server, the user database including micropayment user account information.

4. The method of claim 1, further comprising maintaining a vendor database in the micropayment service provider server, the vendor database including micropayment vendor account information.

5. The method of claim 1, further comprising maintaining a transaction database in the micropayment service provider server comprising records of electronic transactions involving use of the electronic tokens at the plurality of vendor web servers.

6. The method of claim 1, wherein the electronic tokens are issued directly to the user by the micropayment service provider or through the plurality of vendor web sites.

7. The method of claim 6, wherein the electronic tokens issued directly to the user by the micropayment service provider or through the plurality of vendor web sites comprise a plurality of incentive tokens, each incentive token in the plurality of incentive tokens designed to provide incentives to users at the sole discretion of the issuing party.

8. The method of claim 1, wherein the micropayment service provider provides each user a plurality of micropayment user accounts, and the plurality of micropayment user accounts are opened by the user through one or more of: a web site hosted at the micropayment service provider server; a link on the plurality of vendor web sites to the web site hosted at the micropayment service provider server; and a customer service representative of the micropayment service provider.

9. The method of claim 8, wherein each micropayment user account in the plurality of micropayment user accounts stores a subset of the electronic tokens purchased with a different currency.

10. The method of claim 8, wherein the micropayment service provider provides a micropayment user interface to the user when the micropayment user account is opened by the user, the micropayment user interface allowing the user to check the status of the micropayment user account.

11. The method of claim 1, wherein the micropayment service provider provides a micropayment vendor application program interface to the plurality of vendors when the micropayment vendor accounts are opened by the plurality of vendors, the micropayment vendor application program interface allowing the plurality of vendors to offer electronic tokens as a payment method to the user.

12. The method of claim 1, further comprising rewarding one of the plurality of vendors for attracting a user to use electronic tokens for an electronic transaction.

13. The method of claim 1, wherein the micropayment service provider server facilitates user's purchase of content from the plurality of vendors without requiring multiple log-in and check-out procedures at each and every vendor web site.

14. The method of claim 1, wherein the micropayment service provider server enables a user to automatically dispute an unauthorized charge in the micropayment user account.

15. The method of claim 1, wherein the user may add funds to the micropayment user account prior to or after purchasing tangible goods, content, or services from the vendor.

16. The method of claim 1, wherein settling payments for electronic tokens comprises settling payments with the plurality of vendors according to a pre-determined amount threshold or time threshold.

17. A system for conducting electronic commerce transactions between a user and a plurality of vendors offering tangible goods, content, or services for rental or sale at a plurality of vendor web sites, without the user having to disclose personal information to one or more of the plurality of vendors, the system comprising:
a micropayment service provider server;
a micropayment account user interface; and
a micropayment vendor application program interface.

18. The system of claim 17, wherein the micropayment service provider server comprises:
a routine for issuing a plurality of electronic tokens from the micropayment service provider server;
a user database routine for updating records relating to the electronic tokens issued to the user;
a vendor database routine for updating records relating to purchases made by the user using electronic tokens at the plurality of vendor web sites; and
a transaction database routine for updating records of electronic transactions involving use of the electronic tokens at the plurality of vendor web sites.

19. The system of claim 18, wherein the micropayment service provider server further comprises a routine for recording a royalty transaction for each electronic transaction conducted at the plurality of vendor web sites using the electronic tokens.

20. The system of claim 18, wherein the micropayment service provider server further comprises a routine to compute the royalty to compensate the author, publisher or other owner of intellectual property of each content sold through the electronic transaction.

21. The system of claim 18, wherein the micropayment service provider server further comprises a routine allowing the user to purchase content at the plurality of vendor web sites without requiring multiple log-in and check-out procedures at each and every vendor web site.

22. The system of claim 18, wherein the micropayment service provider server further comprises a routine allowing the user to instantly view a summary of the user's purchases at the plurality of vendor web sites.

23. The system of claim 18, wherein the micropayment service provider server further comprises a routine allowing the user to set a threshold for purchasing tangible goods, content, or services, the threshold comprising either a total amount per electronic transaction or a total spending amount within a predetermined time period.

24. The system of claim 18, wherein the micropayment service provider server further comprises a routine allowing the user to set a spending threshold at a plurality of vendor web sites.

25. The system of claim 18, wherein the micropayment service provider server further comprises a routine to access content from a user's summary of purchased content without requiring a user to re-visit the content provider's web site.

26. The system of claim 18, wherein the micropayment service provider server further comprises a security routine that sets a pre-determined time period after the user logs in at the micropayment service provider server for allowing the user to purchase content at the plurality of vendor web sites.

27. The system of claim 18, wherein the micropayment service provider server further comprises a security routine to prevent unauthorized downloading of content from the plurality of vendor web sites including encryption of a user login identification with a time variant encryption key.

28. The system of claim 18, wherein the micropayment service provider server further comprises a security routine to prevent unauthorized downloading of content from the plurality of vendor web sites including validation of a plurality of URL addresses corresponding to the plurality of vendor web sites, transaction data and user login identification by the micropayment service provider server.

29. The system of claim 18, wherein the micropayment service provider server further comprises a routine providing security means to prevent unauthorized change of transaction data by creating a transaction ID for the transaction data and limiting transmission of the transaction data between the micropayment service provider server and the plurality of vendor web servers.

30. The system of claim 18, wherein the micropayment service provider server further comprises a routine for settlement of account with the plurality of vendors, according to pre-determined amount thresholds or pre-determined time periods.

31. The system of claim 18, wherein the micropayment service provider server further comprises a routine for transferring tokens from one user's account to another user's account.

32. The system of claim 18, wherein the electronic tokens are issued directly to the user by the micropayment service provider or through the plurality of vendor web sites.

33. The system of claim 18, wherein the micropayment service provider server further comprises a routine for establishing multiple users within one user account, each of the multiple users having the same account privileges.

34. The system of claim 17, wherein the Aid micropayment account user interface comprises routines for allowing the user to check the status of a plurality of micropayment user accounts opened with the micropayment service provider.

35. The system of claim 17, wherein the micropayment account user interface comprises one or more of: a web interface hosted at the micropayment service provider server; a client interface downloaded by the user from the micropayment service provider server; an interactive voice response system; and an offline interface with a customer service representative of the micropayment service provider.

36. The system of claim 35, wherein the web interface and the client interface comprise screens for:
adding funds to the plurality of micropayment user accounts to pay for electronic tokens using multiple currencies;
selecting a plurality of payment methods to add funds to the plurality of micropayment user accounts;
selecting spending limits for the plurality of micropayment user accounts;
viewing a history of transactions recorded on the plurality of micropayment user accounts;
disputing transactions recorded on the plurality of micropayment user accounts; and
accessing the plurality of vendor web sites.

37. The system of claim 36, wherein the plurality of payment methods comprise a plurality of online payment methods and a plurality of offline payment methods.

38. The system of claim 37, wherein the plurality of online payment methods comprise one or more of: credit card payment; electronic check payment; electronic currency payment; and automatic debit on a plurality of bank accounts maintained by the user.

39. The system of claim 37, wherein the plurality of offline payment methods comprise one or more of: check payment; money order payment; purchase order payment; payment by phone; payment through an Internet service provider providing Internet services to the user; payment through a utility company providing utility services to the user; and payment through bills mailed to the user by the micropayment service provider.

40. The system of claim 17, wherein the micropayment account user interface further comprises an interface for allowing the plurality of vendors to manage a plurality of micropayment vendor accounts opened with the micropayment service provider.

41. The system of claim 17, wherein the micropayment vendor application program interface comprises routines for the plurality of vendors to offer electronic tokens as a payment method to the user without having to install client software provided by the micropayment service provider.

42. The system of claim 41, further comprising a routine for transmitting information from the plurality of vendor web servers to the micropayment service provider server when the user is purchasing a tangible good, content, or service at the plurality of vendor web sites, the information comprising information about each and every vendor from which the user is purchasing the tangible good, content, or service and information about the tangible good, content, or service.

43. The system of claim 42, wherein the information about each and every vendor comprises one or more of: vendor login information; web form post parameter; response from the micropayment service provider server authorizing the purchase of the user; and other optional information for internal tracking purposes.

44. The system of claim 42, wherein the information about the content comprises one or more of: title of the content; price of the content; short description of the content; content URL address; number of times to view the content; number of hours to view the content; number of days to view the content; expiration time of the content; and incentive IDs associated with the content.
